(19) United States
(12) Patent Application Publication
(10) Pub. No.: US 2017/0118931 A1
(43) Pub. Date: May 4, 2017

(54) PREVENTION OF ROOT INTRUSION IN SUB-SURFACE STRUCTURES

(71) Applicant: Irrigation & Water Technologies IP Pty Ltd, Rouse Hill (AU)

(72) Inventors: Geoffrey Charles Cresswell, Grose Vale (AU); David Hinton, Rouse Hill (AU)

(73) Assignee: Irrigation & Water Technologies IP Pty Ltd, Rouse Hill (AU)

(21) Appl. No.: 15/312,391

(22) PCT Filed: May 19, 2014
(86) PCT No.: PCT/AU2014/050045

§ 371 Date: Nov. 18, 2016

(51) Int. Cl. A01G 29/00; A01N 59/20; A01N 25/34; A01G 25/06

(52) U.S. Cl. CPC A01G 29/00; A01G 25/06; A01N 59/20; A01N 25/34

(57) ABSTRACT

The invention relates to a geotextile that is treated with: a metal such as copper to prevent plant roots or microorganisms growing on and through the geotextile. The geotextile is used in conjunction with a subsurface fluid supply system, where the treated geotextile prevents the ingress of roots into drippers that are disposed on conduit of the fluid supply system.

### TECHNICAL FIELD

Disclosed herein is a treated geotextile and applications of the geotextile to protect surface and sub-surface structures, such as surface paths, roadways and foundations (including building foundations) and subsurface fluid supply systems (irrigation systems), buried drip pipes, drainage and water storage elements, capillary mats and conduits from damage caused by plant roots or microorganisms and to reduce plant and human pathogen levels in water.

### BACKGROUND TO THE INVENTION

The efficacy of subsurface irrigation systems, such as those described in PCT/AU95/00496 have been well established (Camp, 1998; Lamm, 2002). In particular they offer significant advantages over irrigation systems that apply water to the soil surface. A major advantage is the extent to which water may be used more effectively. By supplying water under the surface of the soil, there is an immediate reduction in wastage due to surface runoff and evaporation. As generally used in this specification, subsurface irrigation refers to irrigation structures that are placed below the surface of the soil at a depth that allows the water emitted there from to move into the root zone of plants. Usually, once the water is emitted, it is conveyed to the roots by capillary action of the soil.

In all subsurface irrigation systems, there is a requirement for a means for conveying the water from the system into the surrounding soil. This may be achieved using a variety of structures including conduits which convey the water and have openings therein through which the water is emitted, to more complex mechanical arrangements that are adapted to more carefully control the rate of water emitted.

All subsurface irrigation systems are at risk of blocking due to the intrusion of plant roots into the water emission arrangement. Roots locate the source of water by following a soil moisture gradient. Root intrusion is quite damaging to the subsurface irrigation system by virtue of the fact that over time, the water emission arrangement will become blocked or at the very least, will be emitting water at a reduced rate. In either case, the subsurface irrigation system will be reduced in efficacy or in extreme cases, cease operation all together. It is important to note that even in arrangements where the water is emitted from very small openings, roots are still able to penetrate such openings and then grow in size until the opening becomes blocked completely.

In the subsurface irrigation system described in PCT/AU95/00496, the geotextile cover over the drippers has been found to restrict but not always prevent the intrusion of roots into the water emission arrangement. Consequently, roots that pass through the geotextile can still enter and block the dripper if conditions are favourable.

It will be appreciated that root intrusion can eventually make a subsurface irrigation system ineffective. The repair of a system damaged in this way of course presents substantial practical difficulties given that effective treatment may well require the removal and replacement of the subsurface irrigation system. It is therefore desirable to prevent such root intrusion and thereby provide a much longer life for the subsurface irrigation system.

This problem of root intrusion has been well recognised but only limited means have been used to address it. Most common preventative measures are based on the incorporation of trifluralin into drip emitters or the slow release of this substance into the irrigation water from a treated water filter. Such usage is described for example in U.S. Pat. No. 5,116,414, WO 2003/039251 and South African patent 86/1133. In all of these, reliance is placed on the trifluralin being released into the soil surrounding the emitter at an effective rate so as to exclude roots from the region of the soil proximate to the emitter. In this way, it is expected that the roots will not enter the emitter.

Trifluralin is a pre-emergent herbicide, an endocrine disruptor and is toxic to aquatic organisms. Despite widespread concerns about possible health risks, trifluralin continues to be used because there is no safe effective alternative. Trifluralin is presently used by Toro Australia in TREFLAN® in their Rootguard product.

Other approaches to root intrusion management are based on killing and removing roots that have already entered drippers. These curative treatments include injections of soluble copper, acid or chlorine into the irrigation water. They are less popular because the chemicals are potentially hazardous to humans and plants and their effect is short lived. This latter fact means the treatments must be repeated frequently which makes them labour intensive.

Netafim has a copper dripper (UniRam™ XR) that comprises a diaphragm cover impregnated with copper oxide as part of the mould. Rainbird has a copper shield inside the dripper as a root deterrent. The roots enter the surface of the dripper but once in contact with the copper shield just inside the orifice it is claimed that the copper will root prune the plant mersitematic tissue.

A geotextile painted with a soluble form of copper (cupric hydroxide) has been shown to help prevent the spread of Phytophthora propagules (Pettitt, Monaghan and Crawford, 2008) in nurseries. Copper is commonly used to control a range of common plant, animal and human diseases and so it is likely that the invention will have wide application in health management.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY OF THE INVENTION

The geotextiles disclosed herein seeks to provide a safer way of preventing root intrusion in drip irrigation lines and other conduits or buried structures as well as inhibiting microbial slimes in geotextiles. It also has applicability to subsurface drainage systems and to systems that provide both subsurface irrigation and subsurface drainage. It also has applicability to surface and subsurface structures subject to damage from root intrusion regardless of whether irrigation and/or drainage is present.

The invention also has the capacity to reduce the transmission of plant, animal and human pathogens in water.

In a first aspect, the invention provides a geotextile comprising:
a plant root inhibiting amount or microorganism inhibiting amount of: one or more metals or one or more metal containing compounds thereof, or a mixture of the foregoing; and
optionally an organic compound selected from a group consisting of: an algaecide, an herbicide, a pesticide, a fungicide, or a mixture thereof, held in a carrier material,
   wherein the one or more metals, the one or more metal containing compounds thereof, or a mixture of the foregoing inhibits the growth of plant roots or microorganisms on or through the geotextile.

In a second aspect, the invention provides use of a geotextile according to the first aspect to protect a surface or a sub-surface structure from damage caused by plant roots or microorganisms.

In a third aspect, the invention provides use of a geotextile according to the first aspect in a subsurface irrigation and/or drainage system of a type in which the geotextile is disposed in proximity to drippers or apertures of an irrigation system and/or entry apertures of a drainage system.

In a fourth aspect, the invention provides a subsurface fluid supply system comprising:
one or more conduits adapted to transport a fluid;
a connector on the one or more conduits adapted to connect to a source of fluid;
one or more fluid drippers or apertures, in each of the conduits; and
a geotextile according to the first aspect to inhibit the growth of plant roots or microorganisms on or through a geotextile disposed in proximity to the one or more fluid drippers or apertures.

In one embodiment of the fourth aspect, the subsurface fluid supply system can further comprise a water impermeable layer.

In another embodiment of the fourth aspect, the subsurface fluid supply system can further comprise a deflector strip which impedes and controls the direction of a fluid discharged from the drippers or apertures. The fluid cannot move through the deflector strip and therefore the deflector strip directs the water discharged from the drippers or apertures, to move, for example, in a horizontally or vertically direction, relative to the position of the deflector strip in relation to the drippers or apertures, through the geotextile material. In one embodiment the deflector strip acts as a physical barrier for the ingress of roots towards the drippers or apertures.

In a fifth aspect, the present invention provides use of geotextile according to the first aspect to prevent roots and/or microorganisms growing in joints present in subsurface conduits.

In one embodiment of the fifth aspect, the conduits can be used to carry electrical cables, copper cables, optical fibre and the like.

In a sixth aspect, the invention provides a method of irrigation, wherein the geotextile according to the first aspect, or the subsurface fluid supply system according to the fourth aspect, is used to irrigate an area of land.

In one embodiment of the sixth aspect, the method of irrigation protects surface and subsurface structures, such as foundations, including building foundations, pavements, roadways, buried drip pipes, drainage and water storage elements, capillary mats and conduits from damage caused by plant roots or microorganisms and to reduce plant and human pathogen levels in water.

In a seventh aspect, the invention provides a method of protecting a surface or a sub-surface structure from damage caused by plant roots or microorganisms, the method comprising providing a geotextile according to the first aspect, above or below the surface or sub-surface structure.

In one embodiment of the seventh aspect, the surface or sub-surface structure is selected from the group comprising: surface paths, roadways, foundations (including building foundations), sub-surface fluid supply systems, sub-surface irrigation systems, buried drip pipes, drainage and water storage elements, capillary mats and conduits.

### DESCRIPTION OF DRAWINGS

Whilst it will be appreciated that a variety of embodiments of the invention may be utilised, in the following, we describe a number of examples of the invention with reference to the following drawings in which:

FIG. 1 schematically partially shows a first subsurface irrigation system;

FIG. 2 schematically partially shows a second subsurface irrigation system;

FIG. 3 schematically partially shows a third subsurface irrigation system;

FIG. 4 schematically partially shows a fourth subsurface irrigation system;

FIG. 5 schematically partially shows a fifth subsurface irrigation system;

FIG. 6 schematically partially shows a sixth subsurface irrigation system;

FIG. 7 schematically partially shows a seventh subsurface irrigation system;

FIG. 8 schematically partially shows an eighth subsurface irrigation system;

FIG. 9 schematically partially shows a ninth subsurface irrigation system;

FIG. 9A schematically partially shows a tenth subsurface irrigation system;

FIG. 10A schematically partially shows an eleventh subsurface irrigation system;

FIG. 10B schematically partially shows a twelfth subsurface irrigation system;

FIG. 10C schematically partially shows a thirteenth subsurface irrigation system;

FIG. 11A schematically partially shows a fourteenth subsurface irrigation system;

FIG. 11B schematically partially shows a fifteenth subsurface irrigation system;

FIG. 11C schematically partially shows a sixteenth subsurface irrigation system;

FIG. 12 shows an established root network for a plant growing in a pot with a geotextile of the invention;

FIG. 13 shows a geotextile of the invention after being removed from a pot with a plant that has established a root network in the presence of the geotextile;

FIG. 14 shows an established root network for a plant growing in a pot with geotextiles of the invention wrapped around pipes; and

FIG. 15 shows geotextiles of the invention wrapped around pipes after being removed from a pot with a plant that has established a root network in the presence of the geotextiles.

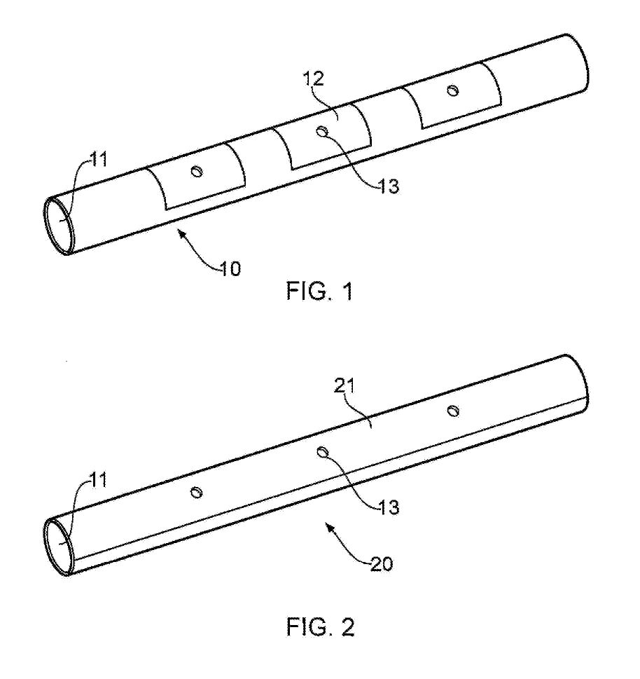

Referring to FIG. 1, there is shown a system 10 which comprises a conduit 11 for carrying water. In this system, a portion of copper containing geotextile 12 is disposed as a discrete portion immediately over dripper 13. The discrete portion 12 is adhered to the conduit. By properly dimensioning the size of the discrete portion 12 in relation to the opening size of dripper 13, when the system is placed in the soil subsurface, intrusion of plant roots into the dripper 13 will be minimised or prevented.

Referring to FIG. 2, there is shown a system 20 which is the same as the system of FIG. 1 with the exception that drippers 13 are covered by a strip 21 of copper containing geotextile. In this case rather than discrete portions 12, the strip 21 is adhered longitudinally so as to cover all of the drippers 13 in its length.

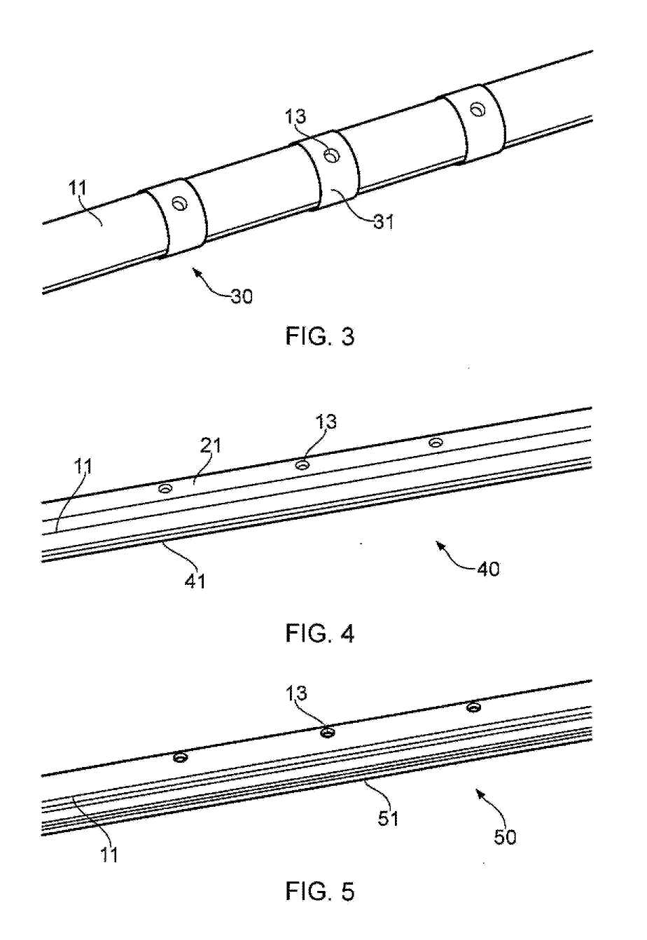

Referring to FIG. 3, there is shown a system 30 which is the same as the system of FIG. 1 with the exception that drippers 13 are covered by a discrete portion 31 that extends completely around conduit 11.

Referring to FIG. 4, there is shown a system 40 which is the same as the system of FIG. 2 with the exception that there is a further longitudinally extending strip 41 of copper containing geotextile on the underside of conduit 11.

Referring to FIG. 5, there is shown a system 50 which is the same as the system of FIG. 2 with the exception that the longitudinally extending strip 51 of copper containing geotextile is on the underside of conduit 11. Thus whilst the strip 51 does not cover dripper 13, it is nevertheless proximate the dripper.

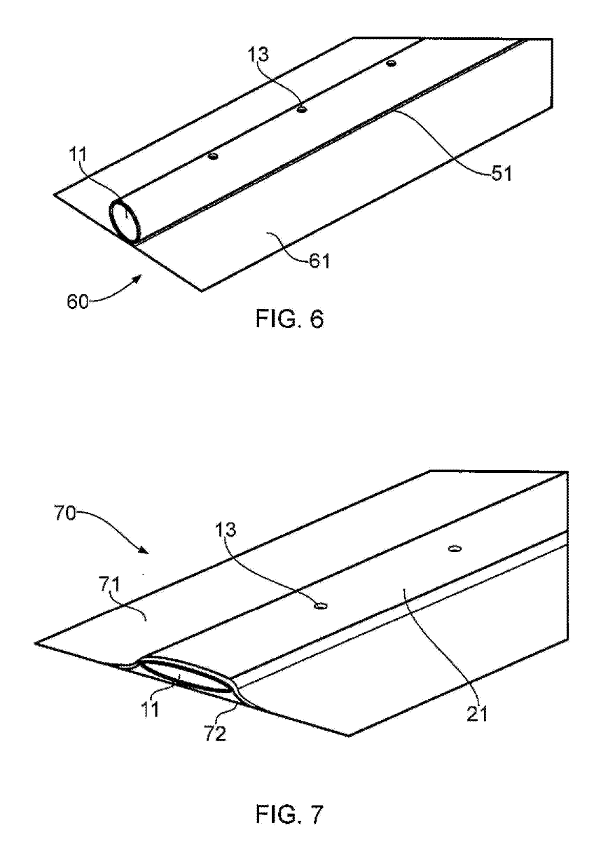

Referring to FIG. 6, there is shown a system 60 which is the same as the system of FIG. 5 with the exception that the longitudinally extending strip 51 of copper containing geotextile on the underside of conduit 11 is sandwiched between conduit 11 and a layer 61 of a water impermeable material, for example polyethylene. In this system, water discharged from dripper 13 is prevented from moving downwardly into the subsoil by the presence of layer 61. In this way, a greater proportion of the water is available to be carried by capillary action to the roots of the plants above the system.

Referring to FIG. 7, there is shown a system 70 which is the same as the system of FIG. 6 with the exception that on the upper side of conduit 11, there is a geotextile layer 71 that extends over the conduit 11 to form a continuous strip which is, for example, 110 mm in width. The geotextile layer 21 overlaying layer 71 along the length of the conduit 11 is treated with copper in a narrow band which is, for example 20 mm wide in the centre. On the underside of conduit 11 is a layer 72 of water impermeable material, for example polyethylene, disposed so as to sandwich conduit 11 between layers 71 and 72. In an alternative embodiment, geotextile layer 21 can be below geotextile layer 71.

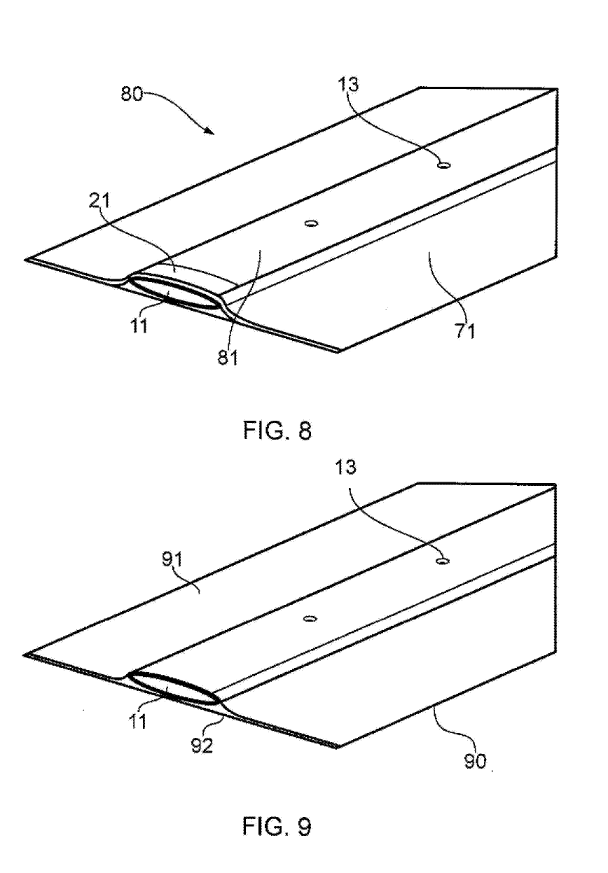

Referring to FIG. 8, there is shown a system 80 which is the same as the system of FIG. 7 with the exception that a deflector tape 81 is disposed over the geotextile layer 71 treated with copper in a narrow band strip 21. This tape 81 serves to prevent water discharged from the drippers 13 moving vertically through layer 71 to the soil.

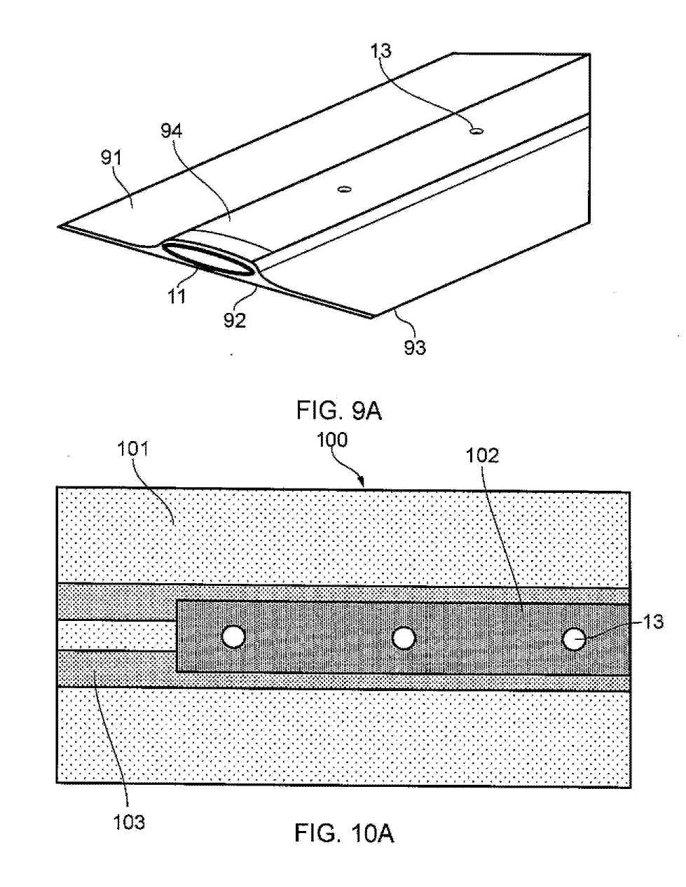

Referring to FIG. 9, there is shown a system 90 in which conduit 11 is sandwiched between an upper layer of copper containing geotextile 91 and a lower water impermeable layer 92. In this example, not only are all drippers 13 covered by the copper containing geotextile layer 91 but the whole combination of the water containing layer is also covered. This arrangement provides maximum protection in that roots penetration to the whole system is minimised or prevented. In this way, roots do not foul any part of the system.

Referring to FIG. 9A, there is shown a system 93 which is the same as the system of FIG. 9 with the exception that a deflector tape 94 is disposed over the geotextile layer 91. This tape 94 serves to prevent water discharged from the drippers 13 moving vertically through layer 91 to the soil.

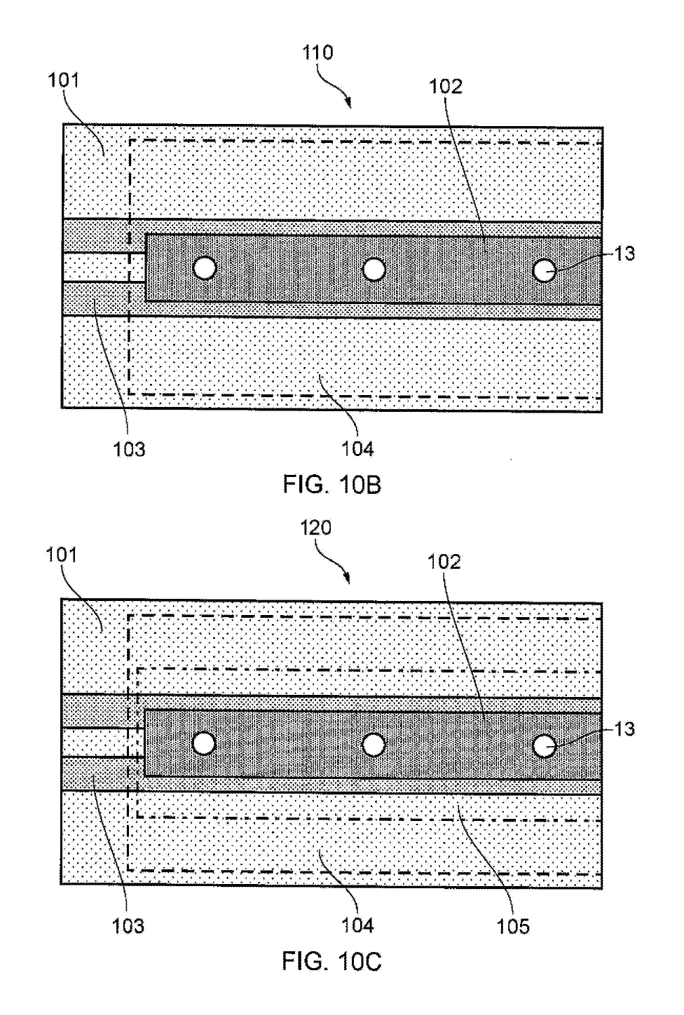

Referring to FIG. 10A, there is shown a system 100 in which there are disposed parallel longitudinally extending strips 103 of copper containing geotextile on a water impermeable layer 101. Desirably the width of the space between the strips 103 corresponds with the width of conduit 102. Conduit 102 comprises drippers 13.

Referring to FIG. 10B, there is shown a system 110 which is the same as the system of FIG. 10A with the exception that a copper containing geotextile layer 104 is disposed over elements 13, 101, 102 and 103.

Referring to FIG. 10C, there is shown a system 120, which is the same as the system of FIG. 10B with the exception that a deflector tape 105 is disposed over the geotextile layer 104. In an alternative embodiment, deflector tape 105 is disposed over elements 13, 101 and 102, but beneath element 104.

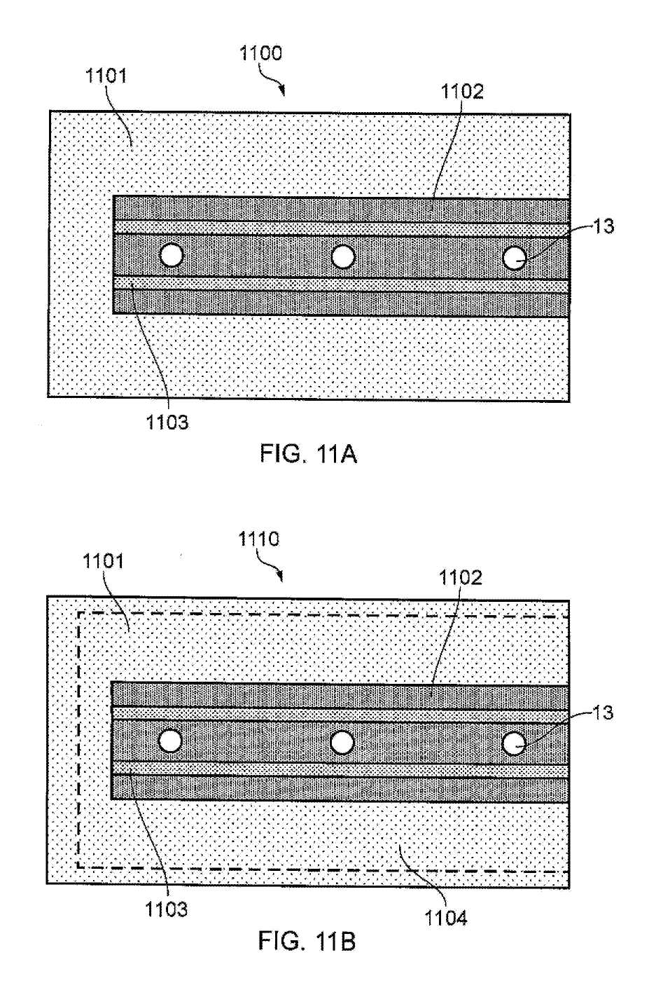

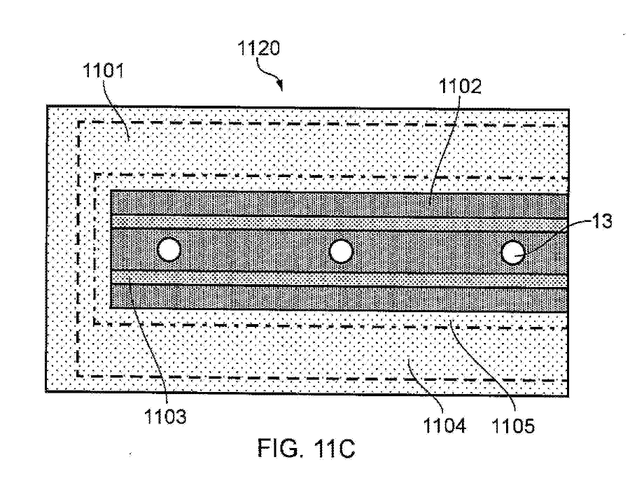

Referring to FIG. 11A, there is shown a system 1100 in which there are disposed parallel longitudinally extending strips 1103 of copper containing geotextile disposed upon conduit 1102. Conduit 1102 is disposed on a water impermeable layer 1101. Conduit 1102 comprises drippers 13.

Referring to FIG. 11B, there is shown a system 1110 which is the same as the system of FIG. 11A with the exception that a copper containing geotextile layer 1104 is disposed over elements 13, 1101, 1102 and 1103.

Referring to FIG. 11C, there is shown a system 1120, which is the same as the system of FIG. 11B with the exception that a deflector tape 1105 is disposed over the geotextile layer 1104. In an alternative embodiment, deflector tape 1105 is disposed over elements 13, 1101 and 1102, but beneath element 1104.

### DETAILED DESCRIPTION OF THE INVENTION

From the foregoing description, it will be evident that the geotextile disclosed herein is particularly advantageous over the use of systems impregnated with trifluralin. The geotextile disclosed herein provides root intrusion protection for an entire system comprising a geotextile as disclosed herein, for example an irrigation system. Hence it is advantageous over systems relying on root intrusion only through the dripper. Metals utilised in geotextiles disclosed herein commonly occur in the environment. Moreover, levels that are likely to enter the soil and groundwater are quite low and therefore pose a minimal threat to the environment.

In addition, the geotextile disclosed herein may be used to readily improve existing subsurface irrigation systems by providing a ready means to prevent or minimise penetration of roots into drippers or apertures used to supply water to the soil. Whilst it has particularly usefulness for systems that already utilise geotextile as a means of dispersing water into the soil, the person skilled in the art will appreciate that when used as a discrete portion, the metal containing geotextile may be adhered proximate a dripper to prevent or minimise root penetration therein.

### Geotextile

A variety of water permeable geotextiles, known to those skilled in the art, may be used in the present geotextile. Although the geotextile is not restricted to a specific material, for example: polyesters, polyamides, polypropylene, polyethylene and other appropriate polyolefin materials, geotextiles with a loose open form are preferred as these have greater hydraulic conductivity.

In one embodiment the geotextile has a density of about 50 g/m² to about 400 g/m², preferably a density of about 120 g/m² to about 200 g/m², most preferably a density of about 50 g/m² to about 200 g/m². Exemplary density ranges include but are not limited to: about 60 g/m² to about 400 g/m²; about 80 g/m² to about 400 g/m²; about 100 g/m² to about 400 g/m²; about 120 g/m² to about 400 g/m²; about 140 g/m² to about 400 g/m²; about 160 g/m² to about 400 g/m²; about 180 g/m² to about 400 g/m²; about 200 g/m² to about 400 g/m²; about 220 g/m² to about 400 g/m²; about 240 g/m² to about 400 g/m²; about 260 g/m² to about 400 g/m²; about 280 g/m² to about 400 g/m²; about 300 g/m² to about 400 g/m²; about 320 g/m² to about 400 g/m²; about 340 g/m² to about 400 g/m²; about 360 g/m² to about 400 g/m²; about 380 g/m² to about 400 g/m²; about 50 g/m² to about 380 g/m²; about 50 g/m² to about 360 g/m²; about 50 g/m² to about 340 g/m²; about 50 g/m² to about 320 g/m²; about 50 g/m² to about 300 g/m²; about 50 g/m² to about 280 g/m²; about 50 g/m² to about 260 g/m²; about 50 g/m² to about 240 g/m²; about 50 g/m² to about 220 g/m²; about 50 g/m² to about 200 g/m²; about 50 g/m² to about 180 g/m²; about 50 g/m² to about 160 g/m²; about 50 g/m² to about 140 g/m²; about 50 g/m² to about 120 g/m²; about 50 g/m² to about 100 g/m²; about 50 g/m² to about 80 g/m²; or about 50 g/m² to about 60 g/m².

In addition, the geotextile may be in the form of a woven, non-woven needle punched and/or heat bonded material.

The size of a geotextile is not restricted and can be advantageously tailored and applied, as required, for a specific need or application, for example to encompass pipes of an irrigation system.

An advantage of the geotextile is that it can be replaced and removed, for example from an irrigation system, if repairs are required, or the dimensions of the geotextile need to be enlarged or reduced in accordance with the requirements for the geotextile.

### Active Compound(s)

A geotextile disclosed herein contains a material, or materials, which act as active compounds to inhibit the growth of plant roots or microorganisms on or through the geotextile.

The active compound, or compounds, can be selected from one or more metals, metal containing compounds thereof, or a mixture of the foregoing. The metal containing compound may be substantially insoluble in water or insoluble in water.

Herein, one or more metal containing compounds, including salts of copper, zinc, aluminium and manganese, can be used as active ingredients in the geotextile. These metal containing compounds may be “substantially insoluble” in water. The term “substantially insoluble” as used in this context for the presently disclosed geotextiles means that about at least 80%, preferably about at least 90%, most preferably about at least 95% of a metal containing compound, including a salts of copper, zinc aluminium or manganese, is insoluble in water at 25° C. For example about at least 81%, about at least 82%, about at least 83%, about at least 84%, about at least 85%, about at least 86%, about at least 87%, about at least 88%, about at least 89%, about at least 90%, about at least 91%, about at least 92%, about at least 93%, about at least 94%, about at least 95%, about at least 96%, about at least 97%, about at least 98%, about at least 99%, or about at least 99.5% of a metal containing compound, for example a salt of copper, zinc, aluminium or manganese, is insoluble in water at 25° C.

The inhibitory effect provided by the one or more metals, metal containing compounds thereof, or a mixture of the foregoing, is believed to rely on a localised release of the metal in a soluble form that can be absorbed by either the root or a microorganism.

Because the metal and their oxides encompassed herein have practically no or low solubility in water, the zone of inhibition around each particle of the metal and its oxide is very narrow. However, the solubility of the metal changes when a particle is contacted by an actively growing root or the cell membrane of a microorganism. Chemical substances excreted by roots and certain microorganisms to aid absorption of mineral nutrients from soil also liberate metal ions from the particle. If the concentration of metal ions is high enough then the root tip or the micro-organism will die. Thus the treated geotextile has no significant inhibitory effect until activated by the target root or microorganism.

Furthermore the low water solubility of the active ingredients means that the treated geotextile will have an extremely long life (potentially several decades) and have little impact on the environment. The low water solubility of the active ingredients means that the active ingredient will not migrate far from the geotextile in the soil environment.

In one embodiment a geotextile disclosed herein contains an amount of one or more metals, one or more metal containing compounds thereof, or a mixture of the foregoing effective to inhibit the growth of plant roots or microorganisms on or through the geotextile.

In another embodiment the one or more metals, one or more metal containing compounds thereof, or mixtures thereof, will have biocidal properties.

Appropriate metal containing compounds include, but are not limited to: oxides, hydroxides, sulphates, nitrates, permanganates, carbonates and fluorides.

In another embodiment the geotextile disclosed herein contains an active compound which is selected from the group consisting of: copper; zinc; aluminium; manganese; water insoluble compounds, including salts, comprising copper, zinc, aluminium or manganese; copper, zinc, aluminium or manganese salts which are substantially insoluble in water; and mixtures of any of the foregoing elements and/or compounds. These metals, alloys, compounds and mixtures thereof are effective to inhibit the growth of plant roots or microorganisms on or through the geotextile.

In another embodiment the metallic salts of copper, manganese, aluminium or zinc will be substantially insoluble in water. Due to their low solubility in water they will only migrate a small distance from the host geotextile in a soil environment once water is applied to the geotextile. The metallic elements and/or salts inhibit the growth of plant roots and/or microorganisms in or through the geotextile in their surrounding soil environment.

In one preferred embodiment a geotextile disclosed herein comprises an active compound which is selected from the group consisting of: copper; compounds, including salts, comprising copper; copper salts which are insoluble or substantially insoluble in water; and mixtures of any of the foregoing elements and/or compounds.

In another embodiment the active ingredients include, but are not limited to:
elemental copper,
elemental zinc,
elemental aluminium,
elemental manganese,
metal containing compounds including, but not limited to: copper oxide, copper sulphate, copper hydroxide, copper nitrate, aluminium sulphate, aluminium nitrate, zinc sulphate, zinc permanganate, zinc carbonate, manganese carbonate, manganese fluoride, manganese hydroxide,
and mixtures of these elements and/or compounds.

In a further embodiment a geotextile disclosed herein comprises elemental copper.

In yet a further embodiment, a geotextile disclosed herein comprises a copper salt.

In yet another embodiment the amount/concentration of the active ingredient or ingredients, or mixtures thereof, within a geotextile disclosed herein is not restricted but can be tailored for specific needs. For example, the higher the concentration of a particular active ingredient (or combination of active ingredients), the higher the protection afforded with regards to root penetration of the geotextile. Conversely, the lower the concentration of the active ingredient (or active ingredients), the lower the protection with regards to root penetration through the geotextile. This is advantageous as the geotextile can be adapted for specific general requirements, and possibly for specific irrigation requirements. For example, if the geotextile is to be applied in an irrigated area comprising large trees, higher levels of active ingredient(s) can be incorporated into the geotextile in order to combat aggressive roots. Similarly, if a surface or subsurface structure requires maximum protection from the effects of roots (for example building foundations, pavements and roadways), then a higher concentration of a particular active ingredient is incorporated within a geotextile disclosed herein. Alternatively, if the geotextile is to be used in an irrigated area where there is a reduced chance of root intrusion through a geotextile, a low concentration of active ingredient(s) can be incorporated within the geotextile accordingly.

When the active ingredient is a powder, for example a metal powder, it is incorporated into the geotextile at a biologically effective rate that varies with the metal and the form used as well as the application. Since copper is a more effective root inhibitor than aluminium then a lower rate of addition can be used. However, because plants can differ in their sensitivity to metals then the lowest effective rate for use in the geotextile is likely to differ with plant species.

Herein the values recited as “g/m²” refer to the amount of an element, such as a metal, or a compound, such as a metal compound including metal salts, present in grams per square metre of geotextile.

In one embodiment the geotextile comprises a metal as an active ingredient, wherein the metal is present in the geotextile in an amount from about 20 g/m² to about 200 g/m², preferably from about 40 g/m² to about 100 g/m², most preferably from about 40 g/m² to about 80 g/m². Exemplary ranges include, but are not limited to: about 40 g/m² to about 200 g/m²; about 60 g/m² to about 200 g/m²; about 80 g/m² to about 200 g/m²; about 100 g/m² to about 200 g/m²; about 120 g/m² to about 200 g/m²; about 140 g/m² to about 200 g/m²; about 160 g/m² to about 200 g/m²; about 180 g/m² to about 200 g/m²; about 20 g/m² to about 180 g/m²; about 20 g/m² to about 160 g/m²; about 20 g/m² to about 140 g/m²; about 20 g/m² to about 120 g/m²; about 20 g/m² to about 100 g/m²; about 20 g/m² to about 80 g/m²; about 20 g/m² to about 60 g/m²; or about 20 g/m² to about 40 g/m².

In one embodiment the geotextile comprises elemental copper as an active ingredient, wherein the copper is present in the geotextile in an amount from about 1 g/m² to about 400 g/m², preferably from about 20 g/m² to about 200 g/m², most preferably from about 5 g/m² to about 20 g/m². Exemplary ranges include, but are not limited to: about 20 g/m² to about 400 g/m²; about 40 g/m² to about 400 g/m²; about 60 g/m² to about 400 g/m²; about 80 g/m² to about 400 g/m²; about 100 g/m² to about 400 g/m²; about 120 g/m² to about 400 g/m²; about 140 g/m² to about 400 g/m²; about 160 g/m² to about 400 g/m²; about 180 g/m² to about 400 g/m²; about 200 g/m² to about 400 g/m²; about 220 g/m² to about 400 g/m²; about 240 g/m² to about 400 g/m²; about 260 g/m² to about 400 g/m²; about 280 g/m² to about 400 g/m²; about 300 g/m² to about 400 g/m²; about 320 g/m² to about 400 g/m²; about 340 g/m² to about 400 g/m²; about 360 g/m² to about 400 g/m²; about 380 g/m² to about 400 g/m²; about 1 g/m² to about 380 g/m²; about 1 g/m² to about 360 g/m²; about 1 g/m² to about 340 g/m²; about 1 g/m² to 1 g/m² to about 260 g/m²; about 1 g/m² to about 240 g/m²; about 1 g/m² to about 220 g/m²; about 1 g/m² to about 200 g/m²; about 1 g/m² to about 190 g/m²; about 1 g/m² to about 180 g/m²; about 1 g/m² to about 160 g/m²; about 1 g/m² to about 140 g/m²; about 1 g/m² to about 120 g/m²; about 1 g/m² to about 100 g/m²; about 1 g/m² to about 80 g/m²; about 1 g/m² to about 60 g/m²; about 1 g/m² to about 40 g/m²; or about 1 g/m² to about 20 g/m².

In one embodiment the geotextile comprises elemental zinc as an active ingredient, wherein the zinc is present in the geotextile in an amount from about 1 g/m² to about 400 g/m², preferably from about 20 g/m² to about 200 g/m², most preferably from about 5 g/m² to about 20 g/m². Exemplary ranges include, but are not limited to: about 20 g/m² to about 400 g/m²; about 40 g/m² to about 400 g/m²; about 60 g/m² to about 400 g/m²; about 80 g/m² to about 400 g/m²; about 100 g/m² to about 400 g/m²; about 120 g/m² to about 400 g/m²; about 140 g/m² to about 400 g/m²; about 160 g/m² to about 400 g/m²; about 180 g/m² to about 400 g/m²; about 200 g/m² to about 400 g/m²; about 220 g/m² to about 400 g/m²; about 240 g/m² to about 400 g/m²; about 260 g/m² to about 400 g/m²; about 280 g/m² to about 400 g/m²; about 300 g/m² to about 400 g/m²; about 320 g/m² to about 400 g/m²; about 340 g/m² to about 400 g/m²; about 360 g/m² to about 400 g/m²; about 380 g/m² to about 400 g/m²; about 1 g/m² to about 380 g/m²; about 1 g/m² to about 360 g/m²; about 1 g/m² to about 340 g/m²; about 1 g/m² to about 320 g/m²; about 1 g/m² to about 300 g/m²; about 1 g/m² to about 280 g/m²; about 1 g/m² to about 260 g/m²; about 1 g/m² to about 240 g/m²; about 1 g/m² to about 220 g/m²; about 1 g/m² to about 200 g/m²; about 1 g/m² to about 190 g/m²; about 1 g/m² to about 180 g/m²; about 1 g/m² to about 160 g/m²; about 1 g/m² to about 140 g/m²; about 1 g/m² to about 120 g/m²; about 1 g/m² to about 100 g/m²; about 1 g/m² to about 80 g/m²; about 1 g/m² to about 60 g/m²; about 1 g/m² to about 40 g/m²; or about 1 g/m² to about 20 g/m².

In one embodiment the geotextile comprises elemental aluminium as an active ingredient, wherein the aluminium is present in the geotextile in an amount from about 1 g/m² to about 400 g/m², preferably from about 20 g/m² to about 200 g/m², most preferably from about 5 g/m² to about 20 g/m². Exemplary ranges include, but are not limited to: about 20 g/m² to about 400 g/m²; about 40 g/m² to about 400 g/m²; about 60 g/m² to about 400 g/m²; about 80 g/m² to about 400 g/m²; about 100 g/m² to about 400 g/m²; about 120 g/m² to about 400 g/m²; about 140 g/m² to about 400 g/m²; about 160 g/m² to about 400 g/m²; about 180 g/m² to about 400 g/m²; about 200 g/m² to about 400 g/m²; about 220 g/m² to about 400 g/m²; about 240 g/m² to about 400 g/m²; about 260 g/m² to about 400 g/m²; about 280 g/m² to about 400 g/m²; about 300 g/m² to about 400 g/m²; about 320 g/m² to about 400 g/m²; about 340 g/m² to about 400 g/m²; about 360 g/m² to about 400 g/m²; about 380 g/m² to about 400 g/m²; about 1 g/m² to about 380 g/m²; about 1 g/m² to about 360 g/m²; about 1 g/m² to about 340 g/m²; about 1 g/m² to about 320 g/m²; about 1 g/m² to about 300 g/m²; about 1 g/m² to about 280 g/m²; about 1 g/m² to about 260 g/m²; about 1 g/m² to about 240 g/m²; about 1 g/m² to about 220 g/m²; about 1 g/m² to about 200 g/m²; about 1 g/m² to about 190 g/m²; about 1 g/m² to about 180 g/m²; about 1 g/m² to about 160 g/m²; about 1 g/m² to about 140 g/m²; about 1 g/m² to about 120 g/m²; about 1 g/m² to about 100 g/m²; about 1 g/m² to about 80 g/m²; about 1 g/m² to about 60 g/m²; about 1 g/m² to about 40 g/m²; or about 1 g/m² to about 20 g/m².

In one embodiment the geotextile comprises elemental manganese as an active ingredient, wherein the manganese is present in the geotextile in an amount from about 1 g/m² to about 400 g/m², preferably from about 20 g/m² to about 200 g/m², most preferably from about 5 g/m² to about 20 g/m². Exemplary ranges include, but are not limited to: about 20 g/m² to about 400 g/m²; about 40 g/m² to about 400 g/m²; about 60 g/m² to about 400 g/m²; about 80 g/m² to about 400 g/m²; about 100 g/m² to about 400 g/m²; about 120 g/m² to about 400 g/m²; about 140 g/m² to about 400 g/m²; about 160 g/m² to about 400 g/m²; about 180 g/m² to about 400 g/m²; about 200 g/m² to about 400 g/m²; about 220 g/m² to about 400 g/m²; about 240 g/m² to about 400 g/m²; about 260 g/m² to about 400 g/m²; about 280 g/m² to about 400 g/m²; about 300 g/m² to about 400 g/m²; about 320 g/m² to about 400 g/m²; about 340 g/m² to about 400 g/m²; about 360 g/m² to about 400 g/m²; about 380 g/m² to about 400 g/m²; about 1 g/m² to about 380 g/m²; about 1 g/m² to about 360 g/m²; about 1 g/m² to about 340 g/m²; about 1 g/m² to about 320 g/m²; about 1 g/m² to about 300 g/m²; about 1 g/m² to about 280 g/m²; about 1 g/m² to about 260 g/m²; about 1 g/m² to about 240 g/m²; about 1 g/m² to about 220 g/m²; about 1 g/m² to about 200 g/m²; about 1 g/m² to about 190 g/m²; about 1 g/m² to about 180 g/m²; about 1 g/m² to about 160 g/m²; about 1 g/m² to about 140 g/m²; about 1 g/m² to about 120 g/m²; about 1 g/m² to about 100 g/m²; about 1 g/m² to about 80 g/m²; about 1 g/m² to about 60 g/m²; about 1 g/m² to about 40 g/m²; or about 1 g/m² to about 20 g/m².

In another embodiment the geotextile comprises a water insoluble compound that comprises copper, zinc, aluminium or manganese as an active ingredient, wherein the water insoluble compound is present in the geotextile in an amount from about 1 g/m² to about 400 g/m², preferably from about 20 g/m² to about 200 g/m², most preferably from about 5 g/m² to about 20 g/m². Exemplary ranges include, but are not g/m² to about 400 g/m²; about 80 g/m² to about 400 g/m²; about 100 g/m² to about 400 g/m²; about 120 g/m² to about 400 g/m²; about 140 g/m² to about 400 g/m²; about 160 g/m² to about 400 g/m²; about 180 g/m² to about 400 g/m²; about 200 g/m² to about 400 g/m²; about 220 g/m² to about 400 g/m²; about 240 g/m² to about 400 g/m²; about 260 g/m² to about 400 g/m²; about 280 g/m² to about 400 g/m²; about 300 g/m² to about 400 g/m²; about 320 g/m² to about 400 g/m²; about 340 g/m² to about 400 g/m²; about 360 g/m² to about 400 g/m²; about 380 g/m² to about 400 g/m²; about 1 g/m² to about 380 g/m²; about 1 g/m² to about 360 g/m²; about 1 g/m² to about 340 g/m²; about 1 g/m² to about 320 g/m²; about 1 g/m² to about 300 g/m²; about 1 g/m² to about 280 g/m²; about 1 g/m² to about 260 g/m²; about 1 g/m² to about 240 g/m²; about 1 g/m² to about 220 g/m²; about 1 g/m² to about 200 g/m²; about 1 g/m² to about 190 g/m²; about 1 g/m² to about 180 g/m²; about 1 g/m² to about 160 g/m²; about 1 g/m² to about 140 g/m²; about 1 g/m² to about 120 g/m²; about 1 g/m² to about 100 g/m²; about 1 g/m² to about 80 g/m²; about 1 g/m² to about 60 g/m²; about 1 g/m² to about 40 g/m²; or about 1 g/m² to about 20 g/m².

In another embodiment the geotextile comprises an active ingredient which is a metal compound, such as metal salts, that comprises copper, zinc, aluminium or manganese, or a mixture of metal compounds, wherein a metal compound is present in the geotextile in an amount from about 1 g/m² to about 400 g/m², preferably from about 20 g/m² to about 200 g/m², most preferably from about 5 g/m² to about 20 g/m². Exemplary ranges include, but are not limited to: about 20 g/m² to about 400 g/m²; about 40 g/m² to about 400 g/m²; about 60 g/m² to about 400 g/m²; about 80 g/m² to about 400 g/m²; about 100 g/m² to about 400 g/m²; about 120 g/m² to about 400 g/m²; about 140 g/m² to about 400 g/m²; about 160 g/m² to about 400 g/m²; about 180 g/m² to about 400 g/m²; about 200 g/m² to about 400 g/m²; about 220 g/m² to about 400 g/m²; about 240 g/m² to about 400 g/m²; about 260 g/m² to about 400 g/m²; about 280 g/m² to about 400 g/m²; about 300 g/m² to about 400 g/m²; about 320 g/m² to about 400 g/m²; about 340 g/m² to about 400 g/m²; about 360 g/m² to about 400 g/m²; about 380 g/m² to about 400 g/m²; about 1 g/m² to about 380 g/m²; about 1 g/m² to about 360 g/m²; about 1 g/m² to about 340 g/m²; about 1 g/m² to about 320 g/m²; about 1 g/m² to about 300 g/m²; about 1 g/m² to about 280 g/m²; about 1 g/m² to about 260 g/m²; about 1 g/m² to about 240 g/m²; about 1 g/m² to about 220 g/m²; about 1 g/m² to about 200 g/m²; about 1 g/m² to about 190 g/m²; about 1 g/m² to about 180 g/m²; about 1 g/m² to about 160 g/m²; about 1 g/m² to about 140 g/m²; about 1 g/m² to about 120 g/m²; about 1 g/m² to about 100 g/m²; about 1 g/m² to about 80 g/m²; about 1 g/m² to about 60 g/m²; about 1 g/m² to about 40 g/m²; or about 1 g/m² to about 20 g/m².

In another embodiment the geotextile comprises copper oxide as an active ingredient, wherein the copper oxide is present in the geotextile in an amount from about 1 g/m² to about 400 g/m², preferably from about 20 g/m² to about 200 g/m², most preferably from about 5 g/m² to about 20 g/m². Exemplary ranges include, but are not limited to: about 20 g/m² to about 400 g/m²; about 40 g/m² to about 400 g/m²; about 60 g/m² to about 400 g/m²; about 80 g/m² to about 400 g/m²; about 100 g/m² to about 400 g/m²; about 120 g/m² to about 400 g/m²; about 140 g/m² to about 400 g/m²; about 160 g/m² to about 400 g/m²; about 180 g/m² to about 400 g/m²; about 200 g/m² to about 400 g/m²; about 220 g/m² to about 400 g/m²; about 240 g/m² to about 400 g/m²; about 260 g/m² to about 400 g/m²; about 280 g/m² to about 400 g/m²; about 300 g/m² to about 400 g/m²; about 320 g/m² to about 400 g/m²; about 340 g/m² to about 400 g/m²; about 360 g/m² to about 400 g/m²; about 380 g/m² to about 400 g/m²; about 1 g/m² to about 380 g/m²; about 1 g/m² to about 360 g/m²; about 1 g/m² to about 340 g/m²; about 1 g/m² to about 320 g/m²; about 1 g/m² to about 300 g/m²; about 1 g/m² to about 280 g/m²; about 1 g/m² to about 260 g/m²; about 1 g/m² to about 240 g/m²; about 1 g/m² to about 220 g/m²; about 1 g/m² to about 200 g/m²; about 1 g/m² to about 190 g/m²; about 1 g/m² to about 180 g/m²; about 1 g/m² to about 160 g/m²; about 1 g/m² to about 140 g/m²; about 1 g/m² to about 120 g/m²; about 1 g/m² to about 100 g/m²; about 1 g/m² to about 80 g/m²; about 1 g/m² to about 60 g/m²; about 1 g/m² to about 40 g/m²; or about 1 g/m² to about 20 g/m².

In another embodiment the geotextile comprises an active ingredient selected from: copper sulphate, copper hydroxide, copper nitrate, aluminium sulphate, aluminium nitrate, zinc sulphate, zinc permanganate, zinc carbonate, manganese carbonate, manganese fluoride, and/or manganese hydroxide, wherein one or more active ingredients are present in the geotextile in an amount from about 1 g/m² to about 400 g/m², preferably from about 20 g/m² to about 200 g/m², most preferably from about 5 g/m² to about 20 g/m². Exemplary ranges include, but are not limited to: about 20 g/m² to about 400 g/m²; about 40 g/m² to about 400 g/m²; about 60 g/m² to about 400 g/m²; about 80 g/m² to about 400 g/m²; about 100 g/m² to about 400 g/m²; about 120 g/m² to about 400 g/m²; about 140 g/m² to about 400 g/m²; about 160 g/m² to about 400 g/m²; about 180 g/m² to about 400 g/m²; about 200 g/m² to about 400 g/m²; about 220 g/m² to about 400 g/m²; about 240 g/m² to about 400 g/m²; about 260 g/m² to about 400 g/m²; about 280 g/m² to about 400 g/m²; about 300 g/m² to about 400 g/m²; about 320 g/m² to about 400 g/m²; about 340 g/m² to about 400 g/m²; about 360 g/m² to about 400 g/m²; about 380 g/m² to about 400 g/m²; about 1 g/m² to about 380 g/m²; about 1 g/m² to about 360 g/m²; about 1 g/m² to about 340 g/m²; about 1 g/m² to about 320 g/m²; about 1 g/m² to about 300 g/m²; about 1 g/m² to about 280 g/m²; about 1 g/m² to about 260 g/m²; about 1 g/m² to about 240 g/m²; about 1 g/m² to about 220 g/m²; about 1 g/m² to about 200 g/m²; about 1 g/m² to about 190 g/m²; about 1 g/m² to about 180 g/m²; about 1 g/m² to about 160 g/m²; about 1 g/m² to about 140 g/m²; about 1 g/m² to about 120 g/m²; about 1 g/m² to about 100 g/m²; about 1 g/m² to about 80 g/m²; about 1 g/m² to about 60 g/m²; about 1 g/m² to about 40 g/m²; or about 1 g/m² to about 20 g/m².

In yet another embodiment, the geotextile comprises a mixture of an elemental metal, a water insoluble metal compound, or a metal compound that is substantially insoluble in water, as defined herein, or a mixture thereof, wherein the elements or compounds are present in an amount as defined herein.

In one embodiment the active ingredient or active ingredients (for example one or more metals, one or more metal containing compounds, or a mixture of the foregoing), may be in particulate form.

In another embodiment the active ingredient or active ingredients (for example one or more metals, one or more metal containing compounds, or a mixture of the foregoing), is in the form of foil strips or a mesh.

In one embodiment, the geotextile comprises an active ingredient which is selected from: copper, zinc, aluminium, manganese; metal compounds, including salts, comprising copper, zinc, aluminium or manganese; water insoluble compounds, including salts, comprising copper, zinc, aluminium or manganese; copper, zinc, aluminium or manganese salts which are substantially insoluble in water, or a mixture of the foregoing, wherein the active ingredient is in a particulate form.

In another embodiment, which is particularly applicable to metals, the geotextile comprises an active ingredient which is selected from: copper, zinc, aluminium, manganese; metal compounds, including salts, comprising copper, zinc, aluminium or manganese; water insoluble compounds, including salts, comprising copper, zinc, aluminium or manganese; copper, zinc, aluminium or manganese salts which are substantially insoluble in water, or a mixture of the foregoing, wherein the active ingredient is in the form of foil strips or a mesh.

In another embodiment, the particulate materials are metallic copper and/or copper oxide.

When the active ingredient is in particulate form, the size of the particle has little influence on the effectiveness of the treated geotextile because the inhibition is promoted by direct contact between root and particle and does not rely on the solubility of the metal in the soil. Consequently, considerations of material cost, ease of application and mobility in the geotextile are more important determinants of the optimum particle size.

### Optional Organic Compound

In one embodiment a geotextile disclosed herein further comprises an organic compound which is held in a carrier material. The organic compound effectively inhibits the growth of plant roots or microorganisms on or through the geotextile.

The role of the carrier material is to delay the release of the organic compound and increase the relative lifetime and effectiveness of the geotextile by inhibiting the growth of plant roots or microorganisms through the geotextile.

The organic compound can be incorporated within the carrier material either by physical encapsulation (the carrier physically envelops the organic compound) or by chemical bonding, or a mixture thereof.

In one embodiment the carrier material is selected from the group comprising: clays, zeolites, polymers, gum Arabic, starches and carbon.

In one embodiment the organic compound is a biocide, wherein the biocide is selected from a group comprising, but not limited to: algaecides, herbicides, pesticides, fungicide and mixtures thereof.

Exemplary algaecides include, but are not limited to: copper based algaecides including copper salt based algaecides, silver algaecides including colloidal silver based algaecides and silver salt based algaecides, quat based algaecides and polyquat based algaecides; specific exemplary algaecides include, but are not limited to: benzalkonium chloride, bethoxazin, copper sulphate, cybutryne, dichlone, dichlorophen, diuron, endothal, fentin, hydrated lime, isoproturon, methabenzthiazuron, nabam, oxyfluorfen, pentachlorophenyl laurate, quinoclamine, quinonamid, simazine, and terbutryn.

Exemplary herbicides include, but are not limited to: contact and systemic herbicides. Examples of herbicides include, but are not limited to: amide based herbicides, anilide based herbicides, arylalanine based herbicides, chloroacetanilide based herbicides, sulfonanilide based herbicides, sulfonamide based herbicides, thioamide based herbicides, aromatic acid based herbicides, benzoic acid based herbicides, pyrimidinyloxybenzoic acid based herbicides, pyrimidinylthiobenzoic acid based herbicides, phthalic acid based herbicides, picolinic acid based herbicides, quinolinecarboxylic acid based herbicides, arsenical based herbicides, benzoylcyclohexanedione based herbicides, benzofuranyl alkylsulfonate based herbicides, benzothiazole based herbicides, carbamate based herbicides, carbanilate based herbicides, carbonate based herbicides, cyclohexene oxime based herbicides, cyclopropylisoxazole based herbicides, dicarboximide based herbicides, dinitroaniline based herbicides, dinitrophenol based herbicides, diphenyl ether based herbicides, nitrophenyl ether based herbicides, dithiocarbamate based herbicides, fumigant based herbicides, halogenated aliphatic based herbicides, imidazolinone based herbicides, nitrile based herbicides, organophosphorus based herbicides, oxadiazolone based herbicides, oxazole based herbicides, phenoxy based herbicides, phenoxyacetic based herbicides, phenoxybutyric based herbicides, phenoxypropionic based herbicides, aryloxyphenoxypropionic based herbicides, phenylenediamine based herbicides, pyrazole based herbicides, benzoylpyrazole based herbicides, phenylpyrazole based herbicides, pyridazine based herbicides, pyridazinone based herbicides, pyridine based herbicides, pyrimidinediamine based herbicides, pyrimidinyloxybenzylamine based herbicides, quaternary ammonium based herbicides, thiocarbamate based herbicides, thiocarbonate based herbicides, thiourea based herbicides, triazine based herbicides, chlorotriazine based herbicides, fluoroalkyltriazine based herbicides, methoxytriazine based herbicides, methylthiotriazine based herbicides, triazinone based herbicides, triazole based herbicides, triazolone based herbicides, triazolopyrimidine based herbicides, uracil based herbicides, urea based herbicides, phenylurea based herbicides, sulfonylurea based herbicides, pyrimidinylsulfonylurea based herbicides, triazinylsulfonylurea based herbicides or thiadiazolylurea based herbicides; specific examples include, but are not limited to: allidochlor, amicarbazone, beflubutamid, benzadox, benzipram, bromobutide, cafenstrole, cyprazole, dimethenamid, dimethenamid-P, diphenamid, epronaz, etnipromid, fentrazamide, flucarbazone, flupoxam, fomesafen, halosafen, huangcaoling, isocarbamid, isoxaben, napropamide, napropamide-M, naptalam, pethoxamid, propyzamide, quinonamid, saflufenacil, tebutam, tiafenacil, chloranocryl, cisanilide, clomeprop, cypromid, diflufenican, etobenzanid, fenasulam, flufenacet, flufenican, ipfencarbazone, mefenacet, mefluidide, metamifop, monalide, naproanilide, pentanochlor, picolinafen, propanil, sulfentrazone, triafamone, benzoylprop, flamprop, flamprop-M, acetochlor, alachlor, butachlor, butenachlor, delachlor, diethatyl, dimethachlor, ethachlor, ethaprochlor, metazachlor, metolachlor, S-metolachlor, pretilachlor, propachlor, propisochlor, prynachlor, terbuchlor, thenylchlor, xylachlor, benzofluor, cloransulam, diclosulam, florasulam, flumetsulam, metosulam, perfluidone, profluazol, pyrimisulfan, asulam, carbasulam, fenasulam, oryzalin, penoxsulam, pyroxsulam, bencarbazone, chlorthiamid, cambendichlor, chloramben, dicamba, tricamba, bispyribac, pyriminobac, pyrithiobac, chlorthal, aminopyralid, clopyralid, halauxifen, picloram, quinclorac, quinmerac, cacodylic acid, hexaflurate, fenquinotrione, ketospiradox, mesotrione, sulcotrione, tefuryltrione, tembotrione, benfuresate, ethofumesate, benazolin, benzthiazuron, fenthiaprop, mefenacet, methabenzthiazuron, asulam, carboxazole, chlorprocarb, dichlormate, fenasulam, karbutilate, terbucarb, barban, carbasulam, carbetamide, chlorbufam, chlorpropham, desmedipham, phenisopham, phenmedipham, phenmedipham-ethyl, propham, bromobonil, dinofenate, iodobonil, alloxydim, butroxydim, clethodim, cloproxydim, cycloxydim, profoxydim, sethoxydim, tepraloxydim, tralkoxydim, isoxachlortole, isoxaflutole, cinidon-ethyl, flumezin, flumiclorac, flumioxazin, flumipropyn, benfluralin, butralin, chlornidine, dinitramine, dipropalin, ethalfluralin, fluchloralin, isopropalin, methalpropalin, nitralin, oryzalin, pendimethalin, prodiamine, profluralin, trifluralin, dinofenate, dinoprop, dinosam, dinoseb, dinoterb, etinofen, medinoterb, ethoxyfen, acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen, oxyfluorfen, dazomet, metam, cyanogen, methyl bromide, methyl iodide, alorac, chloropon, dalapon, flupropanate, hexachloroacetone, methyl bromide, methyl iodide, monochloroacetic acid, imazamethabenz, imazamox, imazapic, imazapyr, imazaquin, imazethapyr, ammonium sulfamate, borax, calcium chlorate, copper sulphate, ferrous sulphate, potassium azide, potassium cyanate, sodium azide, sodium chlorate, sulfuric acid, bromobonil, bromoxynil, chloroxynil, dichlobenil, iodobonil, ioxynil, pyraclonil, amiprofos-methyl, amiprophos, anilofos, bensulide, bilanafos, butamifos, clacyfos, fosamine, glufosinate, glufosinate-P, glyphosate, piperophos, shuangjiaancaolin, dimefuron, methazole, oxadiargyl, oxadiazon, carboxazole, fenoxasulfone, isouron, isoxaben, isoxachlortole, isoxaflutole, methiozolin, monisouron, pyroxasulfone, topramezone, bromofenoxim, clomeprop, difenopenten, disul, erbon, etnipromid, fenteracol, trifopsime, clacyfos, cloprop, dichlorprop, dichlorprop-P, fenoprop, mecoprop, mecoprop-P, chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, kuicaoxi, metamifop, propaquizafop, quizalofop, quizalofop-P, trifop, dinitramine, prodiamine, azimsulfuron, difenzoquat, halosulfuron, metazachlor, metazosulfuron, pyrazosulfuron, pyroxasulfone, benzofenap, pyrasulfotole, pyrazolynate, pyrazoxyfen, topramezone, fluazolate, nipyraclofen, pinoxaden, pyraflufen, credazine, cyclopyrimorate, pyridafol, pyridate, brompyrazon, chloridazon, dimidazon, flufenpyr, metflurazon, norflurazon, oxapyrazon, pydanon, aminopyralid, cliodinate, clopyralid, diflufenican, dithiopyr, flufenican, fluroxypyr, halauxifen, haloxydine, picloram, picolinafen, pyriclor, pyroxsulam, thiazopyr, triclopyr, iprymidam, tioclorim, pyribambenz-isopropyl, pyribambenz-propyl, cyperquat, diethamquat, difenzoquat, diquat, morfamquat, paraquat, butylate, cycloate, di-allate, esprocarb, ethiolate, isopolinate, methiobencarb, molinate, orbencarb, pebulate, prosulfocarb, pyributicarb, sulfallate, thiobencarb, tiocarbazil, tri-allate, vernolate, dimexano, proxan, methiuron, dipropetryn, trihydroxytriazine, atrazine, chlorazine, cyanazine, cyprazine, eglinazine, ipazine, mesoprazine, procyazine, proglinazine, propazine, sebuthylazine, simazine, terbuthylazine, trietazine, indaziflam, triaziflam, atraton, methometon, prometon, secbumeton, simeton, terbumeton, ametryn, aziprotryne, cyanatryn, desmetryn, dimethametryn, methoprotryne, prometryn, simetryn, terbutryn, ametridione, amibuzin, ethiozin, hexazinone, isomethiozin, metamitron, metribuzin, amitrole, cafenstrole, epronaz, flupoxam, amicarbazone, bencarbazone, carfentrazone, flucarbazone, ipfencarbazone, propoxycarbazone, sulfentrazone, thiencarbazone, cloransulam, diclosulam, florasulam, flumetsulam, metosulam, penoxsulam, pyroxsulam, benzfendizone, bromacil, butafenacil, flupropacil, isocil, lenacil, saflufenacil, terbacil, tiafenacil, benzthiazuron, cumyluron, cycluron, dichloralurea, diflufenzopyr, isonoruron, isouron, methabenzthiazuron, monisouron, noruron, anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, thidiazuron, amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, zuomihuanglong, chlorsulfuron, cinosulfuron, ethametsulfuron, iodosulfuron, iofensulfuron, metsulfuron, prosulfuron, thifensulfuron, triasulfuron, tribenuron, triflusulfuron, tritosulfuron, buthiuron, ethidimuron, tebuthiuron, thiazafluron, thidiazuron, acrolein, allyl alcohol, aminocyclopyrachlor, azafenidin, bentazone, bentranil, benzobicyclon, bicyclopyrone, buthidazole, calcium cyanamide, chlorfenac, chlorfenprop, chlorflurazole, chlorflurenol, cinmethylin, clomazone, cresol, cyanamide, ortho-dichlorobenzene, dimepiperate, dithioether, endothal, fluoromidine, fluridone, flurochloridone, flurtamone, fluthiacet, funaihecaoling, herbimycin, huancaiwo, indanofan, methoxyphenone, methyl isothiocyanate, oxaziclomefone, pelargonic acid, pentachlorophenol, pentoxazone, phenylmercury acetate, prosulfalin, pyribenzoxim, pyriftalid, quinoclamine, rhodethanil, sulglycapin, tavron, thidiazimin, tridiphane, trimeturon, tripropindan and tritac.

Exemplary pesticides include, but are not limited to: pyrethroids, organophosphates, carbamates, thiocarbamates, or organochlorines including chlorinated hydrocarbons; specific examples include, but are not limited to: azinphosmethyl, chlorpyrifos, diazinon, dimethoate, fenthion, malathion, naled, parathion, phorate, temephos, trichlorfo, aldrin, chlordane, dieldrin, endolsulfan, endrin, lindane, methoxychlor, carbaryl, propoxur, methomyl, carbofuran, thiodicarb, barban, propham, triallate, maneb, nabam, cyhalothrin, cypermethrin, deltamethrin, esfenvalerate or permethrin.

Exemplary fungicides include, but are not limited to: natural plant oils, natural sulphur based fungicides, aliphatic nitrogen based fungicides, amide based fungicides, acylamino acid based fungicides, anilide based fungicides, benzanilide based fungicides, furanilide based fungicides, sulfonanilide based fungicides, benzamide based fungicides, furamide based fungicides, phenylsulfamide based fungicides, sulfonamide based fungicides, valinamide based fungicides, antibiotic based fungicides, strobilurin based fungicides, methoxyacrylate strobilurin based fungicides, methoxycarbanilate strobilurin based fungicides, methoxyiminoacetamide strobilurin based fungicides, methoxyiminoacetate strobilurin based fungicides, arsenical based fungicides, aryl phenyl ketone based fungicides, benzimidazole based fungicides, benzimidazole precursor based fungicides, benzothiazole based fungicides, bridged diphenyl based fungicides, carbamate based fungicides, benzimidazolylcarbamate based fungicides, carbanilate based fungicides, conazole based fungicides, conazole fungicides that are based on imidazoles, conazole fungicides that are based on triazoles, copper based fungicides, cyanoacrylate based fungicides, dicarboximide based fungicides, dichlorophenyl dicarboximide based fungicides, phthalimide based fungicides, dinitrophenol based fungicides, dithiocarbamate based fungicides, cyclic dithiocarbamate based fungicides, polymeric dithiocarbamate based fungicides, dithiolane based fungicides, fumigant based fungicides, hydrazide based fungicides, imidazole based fungicides, mercury based fungicides, inorganic mercury based fungicides, organomercury based fungicides, morpholine based fungicides, organophosphorus based fungicides, organotin based fungicides, oxathiin based fungicides, oxazole based fungicides, polysulfide based fungicides, pyrazole based fungicides, pyridine based fungicides, pyrimidine based fungicides, anilinopyrimidine based fungicides, pyrrole based fungicides, quaternary ammonium based fungicides, quinoline based fungicides, quinone based fungicides, quinoxaline based fungicides, thiadiazole based fungicides, thiazole based fungicides, thiazolidine based fungicides, thiocarbamate based fungicides, thiophene based fungicides, triazine based fungicides, triazole based fungicides, triazolopyrimidine based fungicides, urea based fungicides or zinc based fungicides; specific based fungicides include, but are not limited to: Neem oil, mustard, butylamine, cymoxanil, dodicin, dodine, guazatine, iminoctadine, benzovindiflupyr, carpropamid, chloraniformethan, cyflufenamid, diclocymet, diclocymet, dimoxystrobin, fenaminstrobin, fenoxanil, flumetover, furametpyr, isofetamid, isopyrazam, mandestrobin, mandipropamid, metominostrobin, orysastrobin, penthiopyrad, prochloraz, quinazamid, silthiofam, triforine, benalaxyl, benalaxyl-M, furalaxyl, metalaxyl, metalaxyl-M, pefurazoate, valifenalate, benalaxyl, benalaxyl-M, bixafen, boscalid, carboxin, fenhexamid, fluxapyroxad, isotianil, metalaxyl, metalaxyl-M, metsulfovax, ofurace, oxadixyl, oxycarboxin, penflufen, pyracarbolid, sedaxane, thifluzamide, tiadinil, vangard, benodanil, flutolanil, mebenil, mepronil, salicylanilide, tecloftalam, fenfuram, furalaxyl, furcarbanil, methfuroxam, flusulfamide, benzohydroxamic acid, fluopicolide, fluopyram, tioxymid, trichlamide, zarilamid, zoxamide, cyclafuramid, furmecyclox, dichlofluanid, tolylfluanid, amisulbrom, cyazofamid, benthiavalicarb, iprovalicarb, aureofungin, blasticidin-S, cycloheximide, griseofulvin, kasugamycin, moroxydine, natamycin, polyoxins, polyoxorim, streptomycin, validamycin, fluoxastrobin, mandestrobin, azoxystrobin, bifujunzhi, coumoxystrobin, enoxastrobin, flufenoxystrobin, jiaxiangjunzhi, picoxystrobin, pyraoxystrobin, pyraclostrobin, pyrametostrobin, triclopyricarb, dimoxystrobin, fenaminstrobin, metominostrobin, orysastrobin, kresoxim-methyl, trifloxystrobin, biphenyl, chlorodinitronaphthalenes, chloroneb, chlorothalonil, cresol, dicloran, fenjuntong, hexachlorobenzene, pentachlorophenol, quintozene, sodium pentachlorophenoxide, tecnazene, trichlorotrinitrobenzenes, asomate, urbacide, metrafenone, pyriofenone, albendazole, benomyl, carbendazim, chlorfenazole, cypendazole, debacarb, fuberidazole, mecarbinzid, rabenzazole, thiabendazole, furophanate, thiophanate, thiophanate-methyl, bentaluron, benthiavalicarb, benthiazole, chlobenthiazone, probenazole, allicin, berberine, carvacrol, carvone, osthol, sanguinarine, santonin, bithionol, dichlorophen, diphenylamine, hexachlorophene, parinol, benthiavalicarb, furophanate, iodocarb, iprovalicarb, picarbutrazox, propamocarb, pyribencarb, thiophanate, thiophanate-methyl, tolprocarb, albendazole, benomyl, carbendazim, cypendazole, debacarb, mecarbinzid, diethofencarb, pyraclostrobin, pyrametostrobin, triclopyricarb, climbazole, clotrimazole, imazalil, oxpoconazole, prochloraz, triflumizole, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, acypetacs-copper, Bordeaux mixture, Burgundy mixture, Cheshunt mixture, copper acetate, copper carbonate, copper hydroxide, copper naphthenate, copper oleate, copper oxychloride, copper silicate, copper sulphate, copper sulphate, copper zinc chromate, cuprobam, cuprous oxide, phenamacril, famoxadone, fluoroimide, chlozolinate, dichlozoline, iprodione, isovaledione, myclozolin, procymidone, vinclozolin, captafol, captan, ditalimfos, folpet, thiochlorfenphim, binapacryl, dinobuton, meptyldinocap, dinocton, dinopenton, dinosulfon, dinoterbon, amobam, asomate, azithiram, carbamorph, cufraneb, cuprobam, disulfiram, ferbam, metam, nabam, tecoram, thiram, urbacide, ziram, dazomet, mancozeb, maneb, metiram, polycarbamate, propineb, zineb, isoprothiolane, saijunmao, carbon disulfide, cyanogen, dithioether, methyl bromide, methyl iodide, sodium tetrathiocarbonate, benquinox, saijunmao, cyazofamid, fenamidone, fenapanil, glyodin, iprodione, isovaledione, pefurazoate, triazoxide, climbazole, clotrimazole, imazalil, oxpoconazole, prochloraz, triflumizole, potassium azide, potassium thiocyanate, sodium azide, sulfur, mercuric chloride, mercuric oxide, mercurous chloride, (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate, aldimorph, benzamorf, carbamorph, dimethomorph, dodemorph, fenpropimorph, flumorph, tridemorph, ampropylfos, ditalimfos, edifenphos, fosetyl, hexylthiofos, inezin, iprobenfos, izopamfos, kejunlin, phosdiphen, pyrazophos, tolclofos-methyl, triamiphos, decafentin, fentin, tributyltin oxide, carboxin, oxycarboxin, chlozolinate, dichlozoline, drazoxolon, famoxadone, hymexazol, metazoxolon, myclozolin, oxadixyl, oxathiapiprolin, pyrisoxazole, vinclozolin, barium polysulfide, calcium polysulfide, potassium polysulfide, sodium polysulfide, benzovindiflupyr, bixafen, fenpyrazamine, fluxapyroxad, furametpyr, isopyrazam, oxathiapiprolin, penflufen, penthiopyrad, pyraclostrobin, pyrametostrobin, pyraoxystrobin, rabenzazole, sedaxane, boscalid, buthiobate, dipyrithione, fluazinam, fluopicolide, fluopyram, parinol, picarbutrazox, pyribencarb, pyridinitril, pyrifenox, pyrisoxazole, pyroxychlor, pyroxyfur, triclopyricarb, bupirimate, diflumetorim, dimethirimol, ethirimol, fenarimol, ferimzone, nuarimol, triarimol, cyprodinil, mepanipyrim, pyrimethanil, dimetachlone, fenpiclonil, fludioxonil, fluoroimide, berberine, sanguinarine, ethoxyquin, halacrinate, 8-hydroxyquinoline sulphate, quinacetol, quinoxyfen, tebufloquin, chloranil, dichlone, dithianon, chinomethionat, chlorquinox, thioquinox, etridiazole, saisentong, zinc thiazole, ethaboxam, isotianil, metsulfovax, octhilinone, oxathiapiprolin, thiabendazole, thifluzamide, flutianil, thiadifluor, methasulfocarb, prothiocarb, ethaboxam, isofetamid, silthiofam, anilazine, amisulbrom, bitertanol, fluotrimazole, huanjunzuo, triazbutil, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, ametoctradin, bentaluron, pencycuron, quinazamid, acypetacs-zinc, copper zinc chromate, cufraneb, mancozeb, metiram, polycarbamate, polyoxorim-zinc, propineb, zinc naphthenate, zinc thiazole, zinc trichlorophenoxide, zineb, ziram, acibenzolar, acypetacs, allyl alcohol, benzalkonium chloride, bethoxazin, bromothalonil, chitosan, chloropicrin, dehydroacetic acid, diclomezine, diethyl pyrocarbonate, ethylicin, fenaminosulf, fenitropan, fenpropidin, formaldehyde, furfural, hexachlorobutadiene, methyl isothiocyanate, nitrostyrene, nitrothal-isopropyl, pentachlorophenyl laurate, 2-phenylphenol, phthalide, piperalin, propamidine, proquinazid, pyroquilon, sodium orthophenylphenoxide, spiroxamine, sultropen, thicyofen or tricyclazole.

In yet another embodiment the amount/concentration of the biocides, including but not limited to: algaecides, herbicides, fungicide and pesticides, within a geotextile disclosed herein is not restricted but can be tailored for specific needs. For example, the higher the concentration of a particular organic compound that inhibits the growth of plant roots or microorganisms on or through the geotextile, the higher the protection afforded with regards to root penetration of the geotextile.

The concentrations for algaecides, herbicides and pesticides will have to follow the labelled instruction for use. An exemplary concentration range for algaecides is 5% to 10% w/w relative to the geotextile. An exemplary concentration range for herbicides is 2.5% to 5% w/w relative to the geotextile. For fungicides and pesticides the authorised label would be have to be followed as per local legal requirements.

Methods to Incorporate Active Ingredient(s) into Geotextile

Examples of methods that incorporate the active ingredient(s) into a geotextile disclosed herein will now be described. Although copper powder is exemplified, it can be exchanged for other active ingredients such as elemental zinc, aluminium or manganese, or alternatively copper, manganese, aluminium or zinc compounds (including compounds which are water insoluble or are substantially insoluble in water), or mixtures thereof accordingly.

Examples of methods that incorporate copper powder into a geotextile disclosed herein include coating a fibre of the geotextile with copper, either by:
a) heat bonding copper to the surface of the geotextile. This can be accomplished by melting fibres used to construct the geotextile or by melting a copper coated polymer powder, for example polyethylene powder;
b) incorporating copper in a binder used to strengthen the geotextile; or
c) heating copper powder and applying it to the geotextile so that it melts the geotextile and lodges particles in the fibres.

Exemplary binders include, but are not limited to: zeolites, sodium alginates, PVP, sodium bentonite starches, yeasts and other clay powders.

With these methods, a relatively uniform distribution of particulate material can be obtained using a vibrating table to drop the powder onto the fabric before it is heated.

Another way of incorporating the active ingredient is by blowing the active ingredient, for example an active ingredient that is a metal, such as copper in a particulate form, on one side of the geotextile while applying a vacuum to the other side of the geotextile. In this way, the particulate material is caused to be deposited and trapped in a specific region of the geotextile.

Alternatively, an active ingredient, for example an active ingredient that is a metal, such as copper, in a particulate form, could be incorporated when the geotextile is used in combination with a dripper. Particles of the active ingredient can be pumped through irrigation water which feeds a dripper. In this way particles would be preferably delivered into the geotextile adjacent to the dripper where a proportion would lodge and provide a protective effect. Application of the product in this way would allow existing textile irrigation systems to be protected against roots and microbial slimes.

In addition, an active ingredient, for example an active ingredient that is a metal, such as copper, in particulate form, could be incorporated into a geotextile by mixing the active ingredient with a bonding agent such as a paint, glue or polymer which will prevent the active ingredient, for example in the form of particles, from being washed out of the geotextile by irrigation or ground water flows.

Furthermore, an active ingredient, for example an active ingredient that is a metal, such as copper, in particulate form, such as a powder, can be incorporated into a geotextile using a roller, such as a rubber roller, on an axel. Here a wheel passes through a container of an active ingredient, for example copper metal powder. The wheel transfers the active ingredient to a surface on the roller. The roller then applies this active ingredient to the geotextile; the active ingredient being caught within the geotextile. The application may be in between a dripper and the geotextile. In one embodiment a portion of the active ingredient may gravitate to an applied base adhesive layer holding the geotextile either side of a drip tape/conduit so as to create a barrier either side of the drip tape and directly above a dripper in the geotextile.

When incorporating an active ingredient, for example a metal, such as copper, into a geotextile disclosed herein, the minimum effective amount of the active ingredient (g/m²) can be reduced by:
1. only treating a narrow band of the geotextile directly over the dripper;
2. when used in an irrigation system, applying the active ingredient in a pattern made up of narrow lines that form a barrier around each emitter of water. This can be done most economically in the form of textile irrigation which has an impermeable deflective tape over the emitter. In this instance ingress of roots can be prevented with two narrow lines of the active ingredient in the geotextile under and on each edge of the deflective tape (as exemplified in FIG. 10A, FIG. 10B and FIG. 10C).
   The organic compounds can be introduced into the geotextile by mixing them with the metal powders using adhesive glues either water based, acrylic or other synthetic base. The pellets would then be sprayed, rolled, heated or adhered to the geotextile fabric in the same arrangements as exemplified for copper in the “Methods to Incorporate Active Ingredient(s) into Geotextile” section, except they would not be injected through the conduits unless their individual particle size does not block an aperture. The adhesive glues could be similar to a PVA glue or could be a natural water based adhesive.

### Applications for Geotextiles Disclosed Herein

In one embodiment a geotextile described herein is used in the management of surface structures including foundations (such as building foundations), pavements and roadways. In a further embodiment a geotextile described herein prevents damage from root intrusion around surface structures (including foundations (such as building foundations), pavements and roadways), while also stabilising the structures by managing the soil moisture levels. A variation in soil moisture, especially in clay soils, is regarded as a problem in this field.

In a preferred embodiment, a geotextile described herein is used with a subsurface fluid supply system to irrigate an area that requires an effective distribution of water, for example to water plants. Depending on the irrigation needs the geotextile can be adapted in shape and size in order to prevent damage to the fluid supply system which is caused by plant roots or microorganisms. For example, the geotextile can be adapted to a size and shape sufficient for a subsurface irrigation system which is used to irrigate potted plants, or a subsurface irrigation system for irrigating a grass lawn. In addition the treated geotextile can reduce plant and human pathogen levels in water that is used to irrigate an area of land. Various configurations for the geotextile and the subsurface fluid supply system will be described with the following embodiments.

In a first embodiment, the fluid supply system of a subsurface fluid supply system may comprise an arrangement whereby overlaying each dripper, there is adhered a discrete portion of geotextile containing an active ingredient or ingredients, as described herein, for example a particulate material. In this arrangement, the discrete portion would be dimensioned to cover the dripper to an extent sufficient so as to effectively minimise or prevent root penetration into the dripper. An exemplified fluid system of the first embodiment is disclosed in FIG. 1.

In a second embodiment, the fluid supply system comprises an arrangement whereby a longitudinally extending strip of geotextile that contains an active ingredient, for example a particulate material, is adhered to a conduit in a manner so that all of the drippers or apertures in the conduit are covered by the treated strip. Whilst this embodiment would require more of the geotextile containing particulate material as compared with the first embodiment that employs discrete portions, it may have manufacturing advantages in terms of the application of a continuous strip of the geotextile containing the active ingredient, for example particulate material. In addition, it will be evident that through the use of a greater amount of geotextile containing the active ingredient, for example particulate material, a higher degree of protection from roots may be achieved. An exemplified fluid system of the second embodiment is disclosed in FIG. 2.

In a third embodiment, the discrete portion of the first embodiment may be extended so that it completely surrounds the portion of the conduit proximate the dripper. Such an arrangement would constitute a sleeve and again may be advantageous in manufacture and again provide a higher level of protection. An exemplified fluid system of the third embodiment is disclosed in FIG. 3.

In a fourth embodiment, a second strip of geotextile containing an active ingredient, for example a particulate material, may be adhered to an opposing side of the conduit of the second embodiment to which a first strip of geotextile containing an active ingredient, for example a particulate material, has been adhered. By applying the second strip, it is anticipated that a higher level of protection from roots will be achieved. An exemplified fluid system of the fourth embodiment is disclosed in FIG. 4.

In a fifth embodiment, a single strip of geotextile containing an active ingredient, for example a particulate material, may be adhered to a side of the conduit opposing the side which incorporates the drippers or apertures. In this embodiment, the area covered by the geotextile containing the active ingredient, for example a particulate material, would need to be carefully determined to ensure that it is sufficiently close to the drippers or apertures, so as to minimise or prevent root penetration. In a variation on this embodiment, the strip of geotextile containing the active ingredient, for example a particulate material, may be sandwiched between the conduit and an underlying water impermeable layer which extends in a plane either side of the conduit. Not only will the water impermeable layer prevent loss of water to the soil below the system, it may also create a zone in the soil immediately overlying the system where root growth is inhibited. An exemplified fluid system of the fifth embodiment is disclosed in FIG. 5, FIG. 6 and FIG. 7. The water impermeable layer is not restricted to a specific material but examples of appropriate materials include: paints, glues (polymers), wax, metal tape and polyethylene.

The subsurface fluid supply systems of the first to fifth embodiments may further comprise a deflector strip which impedes and controls the direction of a fluid discharged from the drippers or apertures. The fluid cannot move through the deflector strip and therefore the deflector strip directs the water discharged from the drippers or apertures to move in a horizontally or vertically direction, relative to the position of the deflector strip in relation to the drippers or apertures, through the geotextile material. In one embodiment the deflector strip acts as a physical barrier for the ingress of roots towards the drippers or apertures.

In preferred embodiments, geotextile containing particulate material may be incorporated into subsurface irrigation systems as taught and disclosed in PCT/AU95/00496, the contents of which are incorporated herein by way of reference.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### Example Embodiments

A. A geotextile comprising:
a plant root inhibiting amount or microorganism inhibiting amount of: one or more metals or one or more metal containing compounds thereof, or a mixture of the foregoing; and
optionally an organic compound selected from a group consisting of: an algaecide, an herbicide, a pesticide, a fungicide, or a mixture thereof, held in a carrier material,
   wherein the one or more metals, the one or more metal containing compounds thereof, or a mixture of the foregoing inhibits the growth of plant roots or microorganisms on or through the geotextile.
   B. The geotextile according to example embodiment A wherein the geotextile comprises one or more metals selected from: copper, zinc, aluminium or manganese, or a mixture thereof.
   C. The geotextile according to example embodiment A or example embodiment B, wherein the geotextile comprises one or more of a metal containing compound selected from: copper compounds, zinc compounds, aluminium compounds or manganese compounds, or a mixture thereof.
   D. The geotextile according to any one of example embodiments A to C, wherein the one or more metal containing compounds are selected from: copper oxide, copper sulphate, copper hydroxide, copper nitrate, aluminium sulphate, aluminium nitrate, zinc sulphate, zinc permanganate, zinc carbonate, manganese carbonate, manganese fluoride, manganese hydroxide, or a mixture thereof.
   E. The geotextile according to any one of example embodiments A to D, wherein the one or more metal containing compounds are substantially insoluble in water or insoluble in water.
   F. The geotextile according to any one of example embodiments A to E, wherein the geotextile comprises metallic copper.
   G. The geotextile according to any one of example embodiments A to F, wherein the geotextile comprises a copper containing compound.
   H. The geotextile according to any one of example embodiments A to G, wherein the one or more metals or one or more metal containing compounds is present in a range selected from: about 1 g/m² to about 400 g/m², or about 20 g/m² to about 200 g/m², or about 40 g/m² to about 100 g/m², or about 40 g/m² to about 80 g/m² or about 5 g/m² to about 20 g/m². Exemplary ranges include, but are not limited to: about 20 g/m² to about 400 g/m²; about 40 g/m² to about 400 g/m²; about 60 g/m² to about 400 g/m²; about 80 g/m² to about 400 g/m²; about 100 g/m² to about 400 g/m²; about 120 g/m² to about 400 g/m²; about 140 g/m² to about 400 g/m²; about 160 g/m² to about 400 g/m²; about 180 g/m² to about 400 g/m²; about 200 g/m² to about 400 g/m²; about 220 g/m² to about 400 g/m²; about 240 g/m² to about 400 g/m²; about 260 g/m² to about 400 g/m²; about 280 g/m² to about 400 g/m²; about 300 g/m² to about 400 g/m²; about 320 g/m² to about 400 g/m²; about 340 g/m² to about 400 g/m²; about 360 g/m² to about 400 g/m²; about 380 g/m² to about 400 g/m²; about 1 g/m² to about 380 g/m²; about 1 g/m² to about 360 g/m²; about 1 g/m² to about 340 g/m²; about 1 g/m² to about 320 g/m²; about 1 g/m² to about 300 g/m²; about 1 g/m² to about 280 g/m²; about 1 g/m² to about 260 g/m²; about 1 g/m² to about 240 g/m²; about 1 g/m² to about 220 g/m²; about 1 g/m² to about 200 g/m²; about 1 g/m² to about 190 g/m²; about 1 g/m² to about 180 g/m²; about 1 g/m² to about 160 g/m²; about 1 g/m² to about 140 g/m²; about 1 g/m² to about 120 g/m²; about 1 g/m² to about 100 g/m²; about 1 g/m² to about 80 g/m²; about 1 g/m² to about 60 g/m²; about 1 g/m² to about 40 g/m²; or about 1 g/m² to about 20 g/m².
   I. The geotextile according to any one of example embodiments A to H, wherein the one or more metals is in a particulate form.
   J. The geotextile according to any one of example embodiments A to I, wherein the one or more metal containing compounds is in a particulate form.
   K. The geotextile according to any one of example embodiments A to H, wherein the one or more metals, one or more metal containing compounds, or a mixture of thereof is in a form selected from the group consisting of a foil strip or a mesh.
   L. The geotextile according to any one of example embodiments A to K, wherein the organic compound inhibits the growth of plant roots or microorganisms on or through the geotextile.
   M. The geotextile according to any one of example embodiments A to L comprising the algaecide, the herbicide, the pesticide, the fungicide, or a mixture thereof, held in a carrier material, wherein:
the algaecide is selected from: copper based algaecides including copper salt based algaecides, silver algaecides including colloidal silver based algaecides and silver salt based algaecides, quat based algaecides, polyquat based algaecides, benzalkonium chloride, bethoxazin, copper sulphate, cybutryne, dichlone, dichlorophen, diuron, endothal, fentin, hydrated lime, isoproturon, methabenzthiazuron, nabam, oxyfluorfen, pentachlorophenyl laurate, quinoclamine, quinonamid, simazine, and terbutryn;
the herbicide is selected from: amide based herbicides, anilide based herbicides, arylalanine based herbicides, chloroacetanilide based herbicides, sulfonanilide based herbicides, sulfonamide based herbicides, thioamide based herbicides, aromatic acid based herbicides, benzoic acid based herbicides, pyrimidinyloxybenzoic acid based herbicides, pyrimidinylthiobenzoic acid based herbicides, phthalic acid based herbicides, picolinic acid based herbicides, quinolinecarboxylic acid based herbicides, arsenical based herbicides, benzoylcyclohexanedione based herbicides, benzofuranyl alkylsulfonate based herbicides, benzothiazole based herbicides, carbamate based herbicides, carbanilate based herbicides, carbonate based herbicides, cyclohexene oxime based herbicides, cyclopropylisoxazole based herbicides, dicarboximide based herbicides, dinitroaniline based herbicides, dinitrophenol based herbicides, diphenyl ether based herbicides, nitrophenyl ether based herbicides, dithiocarbamate based herbicides, fumigant based herbicides, halogenated aliphatic based herbicides, imidazolinone based herbicides, nitrile based herbicides, organophosphorus based herbicides, oxadiazolone based herbicides, oxazole based herbicides, phenoxy based herbicides, phenoxyacetic based herbicides, phenoxybutyric based herbicides, phenoxypropionic based herbicides, aryloxyphenoxypropionic based herbicides, phenylenediamine based herbicides, pyrazole based herbicides, benzoylpyrazole based herbicides, phenylpyrazole based herbicides, pyridazine based herbicides, pyridazinone based herbicides, pyridine based herbicides, pyrimidinediamine based herbicides, pyrimidinyloxybenzylamine based herbicides, quaternary ammonium based herbicides, thiocarbamate based herbicides, thiocarbonate based herbicides, thiourea based herbicides, triazine based herbicides, chlorotriazine based herbicides, fluoroalkyltriazine based herbicides, methoxytriazine based herbicides, methylthiotriazine based herbicides, triazinone based herbicides, triazole based herbicides, triazolone based herbicides, triazolopyrimidine based herbicides, uracil based herbicides, urea based herbicides, phenylurea based herbicides, sulfonylurea based herbicides, pyrimidinylsulfonylurea based herbicides, triazinylsulfonylurea based herbicides, thiadiazolylurea based herbicides, allidochlor, amicarbazone, beflubutamid, benzadox, benzipram, bromobutide, cafenstrole, cyprazole, dimethenamid, dimethenamid-P, diphenamid, epronaz, etnipromid, fentrazamide, flucarbazone, flupoxam, fomesafen, halosafen, huangcaoling, isocarbamid, isoxaben, napropamide, napropamide-M, naptalam, pethoxamid, propyzamide, quinonamid, saflufenacil, tebutam, tiafenacil, chloranocryl, cisanilide, clomeprop, cypromid, diflufenican, etobenzanid, fenasulam, flufenacet, flufenican, ipfencarbazone, mefenacet, mefluidide, metamifop, monalide, naproanilide, pentanochlor, picolinafen, propanil, sulfentrazone, triafamone, benzoylprop, flamprop, flamprop-M, acetochlor, alachlor, butachlor, butenachlor, delachlor, diethatyl, dimethachlor, ethachlor, ethaprochlor, metazachlor, metolachlor, S-metolachlor, pretilachlor, propachlor, propisochlor, prynachlor, terbuchlor, thenylchlor, xylachlor, benzofluor, cloransulam, diclosulam, florasulam, flumetsulam, metosulam, perfluidone, profluazol, pyrimisulfan, asulam, carbasulam, fenasulam, oryzalin, penoxsulam, pyroxsulam, bencarbazone, chlorthiamid, cambendichlor, chloramben, dicamba, tricamba, bispyribac, pyriminobac, pyrithiobac, chlorthal, aminopyralid, clopyralid, halauxifen, picloram, quinclorac, quinmerac, cacodylic acid, hexaflurate, fenquinotrione, ketospiradox, mesotrione, sulcotrione, tefuryltrione, tembotrione, benfuresate, ethofumesate, benazolin, benzthiazuron, fenthiaprop, mefenacet, methabenzthiazuron, asulam, carboxazole, chlorprocarb, dichlormate, fenasulam, karbutilate, terbucarb, barban, carbasulam, carbetamide, chlorbufam, chlorpropham, desmedipham, phenisopham, phenmedipham, phenmedipham-ethyl, propham, bromobonil, dinofenate, iodobonil, alloxydim, butroxydim, clethodim, cloproxydim, cycloxydim, profoxydim, sethoxydim, tepraloxydim, tralkoxydim, isoxachlortole, isoxaflutole, cinidon-ethyl, flumezin, flumiclorac, flumioxazin, flumipropyn, benfluralin, butralin, chlornidine, dinitramine, dipropalin, ethalfluralin, fluchloralin, isopropalin, methalpropalin, nitralin, oryzalin, pendimethalin, prodiamine, profluralin, trifluralin, dinofenate, dinoprop, dinosam, dinoseb, dinoterb, etinofen, medinoterb, ethoxyfen, acifluorfen, aclonifen, bifenox, chlomethoxyfen, chlornitrofen, etnipromid, fluorodifen, fluoroglycofen, fluoronitrofen, fomesafen, fucaomi, furyloxyfen, halosafen, lactofen, nitrofen, nitrofluorfen, oxyfluorfen, dazomet, metam, cyanogen, methyl bromide, methyl iodide, alorac, chloropon, dalapon, flupropanate, hexachloroacetone, methyl bromide, methyl iodide, monochloroacetic acid, imazamethabenz, imazamox, imazapic, imazapyr, imazaquin, imazethapyr, ammonium sulfamate, borax, calcium chlorate, copper sulphate, ferrous sulphate, potassium azide, potassium cyanate, sodium azide, sodium chlorate, sulfuric acid, bromobonil, bromoxynil, chloroxynil, dichlobenil, iodobonil, ioxynil, pyraclonil, amiprofos-methyl, amiprophos, anilofos, bensulide, bilanafos, butamifos, clacyfos, fosamine, glufosinate, glufosinate-P, glyphosate, piperophos, shuangjiaancaolin, dimefuron, methazole, oxadiargyl, oxadiazon, carboxazole, fenoxasulfone, isouron, isoxaben, isoxachlortole, isoxaflutole, methiozolin, monisouron, pyroxasulfone, topramezone, bromofenoxim, clomeprop, difenopenten, disul, erbon, etnipromid, fenteracol, trifopsime, clacyfos, cloprop, dichlorprop, dichlorprop-P, fenoprop, mecoprop, mecoprop-P, chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, kuicaoxi, metamifop, propaquizafop, quizalofop, quizalofop-P, trifop, dinitramine, prodiamine, azimsulfuron, difenzoquat, halosulfuron, metazachlor, metazosulfuron, pyrazosulfuron, pyroxasulfone, benzofenap, pyrasulfotole, pyrazolynate, pyrazoxyfen, topramezone, fluazolate, nipyraclofen, pinoxaden, pyraflufen, credazine, cyclopyrimorate, pyridafol, pyridate, brompyrazon, chloridazon, dimidazon, flufenpyr, metflurazon, norflurazon, oxapyrazon, pydanon, aminopyralid, cliodinate, clopyralid, diflufenican, dithiopyr, flufenican, fluroxypyr, halauxifen, haloxydine, picloram, picolinafen, pyriclor, pyroxsulam, thiazopyr, triclopyr, iprymidam, tioclorim, pyribambenz-isopropyl, pyribambenz-propyl, cyperquat, diethamquat, difenzoquat, diquat, morfamquat, paraquat, butylate, cycloate, di-allate, esprocarb, ethiolate, isopolinate, methiobencarb, molinate, orbencarb, pebulate, prosulfocarb, pyributicarb, sulfallate, thiobencarb, tiocarbazil, tri-allate, vernolate, dimexano, proxan, methiuron, dipropetryn, trihydroxytriazine, atrazine, chlorazine, cyanazine, cyprazine, eglinazine, ipazine, mesoprazine, procyazine, proglinazine, propazine, sebuthylazine, simazine, terbuthylazine, trietazine, indaziflam, triaziflam, atraton, methometon, prometon, secbumeton, simeton, terbumeton, ametryn, aziprotryne, cyanatryn, desmetryn, dimethametryn, methoprotryne, prometryn, simetryn, terbutryn, ametridione, amibuzin, ethiozin, hexazinone, isomethiozin, metamitron, metribuzin, amitrole, cafenstrole, epronaz, flupoxam, amicarbazone, bencarbazone, carfentrazone, flucarbazone, ipfencarbazone, propoxycarbazone, sulfentrazone, thiencarbazone, cloransulam, diclosulam, florasulam, flumetsulam, metosulam, penoxsulam, pyroxsulam, benzfendizone, bromacil, butafenacil, flupropacil, isocil, lenacil, saflufenacil, terbacil, tiafenacil, benzthiazuron, cumyluron, cycluron, dichloralurea, diflufenzopyr, isonoruron, isouron, methabenzthiazuron, monisouron, noruron, anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron, thidiazuron, amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, zuomihuanglong, chlorsulfuron, cinosulfuron, ethametsulfuron, iodosulfuron, iofensulfuron, metsulfuron, prosulfuron, thifensulfuron, triasulfuron, tribenuron, triflusulfuron, tritosulfuron, buthiuron, ethidimuron, tebuthiuron, thiazafluron, thidiazuron, acrolein, allyl alcohol, aminocyclopyrachlor, azafenidin, bentazone, bentranil, benzobicyclon, bicyclopyrone, buthidazole, calcium cyanamide, chlorfenac, chlorfenprop, chlorflurazole, chlorflurenol, cinmethylin, clomazone, cresol, cyanamide, ortho-dichlorobenzene, dimepiperate, dithioether, endothal, fluoromidine, fluridone, flurochloridone, flurtamone, fluthiacet, funaihecaoling, herbimycin, huancaiwo, indanofan, methoxyphenone, methyl isothiocyanate, oxaziclomefone, pelargonic acid, pentachlorophenol, pentoxazone, phenylmercury acetate, prosulfalin, pyribenzoxim, pyriftalid, quinoclamine, rhodethanil, sulglycapin, tavron, thidiazimin, tridiphane, trimeturon, tripropindan or tritac;
the pesticide is selected from: pyrethroids, organophosphates, carbamates, thiocarbamates, organochlorines including chlorinated hydrocarbons, azinphosmethyl, chlorpyrifos, diazinon, dimethoate, fenthion, malathion, naled, parathion, phorate, temephos, trichlorfo, aldrin, chlordane, dieldrin, endolsulfan, endrin, lindane, methoxychlor, carbaryl, propoxur, methomyl, carbofuran, thiodicarb, barban, propham, triallate, maneb, nabam, cyhalothrin, cypermethrin, deltamethrin, esfenvalerate or permethrin; and/or
the fungicide is selected from: natural plant oils, natural sulphur based fungicides, aliphatic nitrogen based fungicides, amide based fungicides, acylamino acid based fungicides, anilide based fungicides, benzanilide based fungicides, furanilide based fungicides, sulfonanilide based fungicides, benzamide based fungicides, furamide based fungicides, phenylsulfamide based fungicides, sulfonamide based fungicides, valinamide based fungicides, antibiotic based fungicides, strobilurin based fungicides, methoxyacrylate strobilurin based fungicides, methoxycarbanilate strobilurin based fungicides, methoxyiminoacetamide strobilurin based fungicides, methoxyiminoacetate strobilurin based fungicides, arsenical based fungicides, aryl phenyl ketone based fungicides, benzimidazole based fungicides, benzimidazole precursor based fungicides, benzothiazole based fungicides, bridged diphenyl based fungicides, carbamate based fungicides, benzimidazolylcarbamate based fungicides, carbanilate based fungicides, conazole based fungicides, conazole fungicides that are based on imidazoles, conazole fungicides that are based on triazoles, copper based fungicides, cyanoacrylate based fungicides, dicarboximide based fungicides, dichlorophenyl dicarboximide based fungicides, phthalimide based fungicides, dinitrophenol based fungicides, dithiocarbamate based fungicides, cyclic dithiocarbamate based fungicides, polymeric dithiocarbamate based fungicides, dithiolane based fungicides, fumigant based fungicides, hydrazide based fungicides, imidazole based fungicides, mercury based fungicides, inorganic mercury based fungicides, organomercury based fungicides, morpholine based fungicides, organophosphorus based fungicides, organotin based fungicides, oxathiin based fungicides, oxazole based fungicides, polysulfide based fungicides, pyrazole based fungicides, pyridine based fungicides, pyrimidine based fungicides, anilinopyrimidine based fungicides, pyrrole based fungicides, quaternary ammonium based fungicides, quinoline based fungicides, quinone based fungicides, quinoxaline based fungicides, thiadiazole based fungicides, thiazole based fungicides, thiazolidine based fungicides, thiocarbamate based fungicides, thiophene based fungicides, triazine based fungicides, triazole based fungicides, triazolopyrimidine based fungicides, urea based fungicides, zinc based fungicides, Neem oil, mustard, butylamine, cymoxanil, dodicin, dodine, guazatine, iminoctadine, benzovindiflupyr, carpropamid, chloraniformethan, cyflufenamid, diclocymet, diclocymet, dimoxystrobin, fenaminstrobin, fenoxanil, flumetover, furametpyr, isofetamid, isopyrazam, mandestrobin, mandipropamid, metominostrobin, orysastrobin, penthiopyrad, prochloraz, quinazamid, silthiofam, triforine, benalaxyl, benalaxyl-M, furalaxyl, metalaxyl, metalaxyl-M, pefurazoate, valifenalate, benalaxyl, benalaxyl-M, bixafen, boscalid, carboxin, fenhexamid, fluxapyroxad, isotianil, metalaxyl, metalaxyl-M, metsulfovax, ofurace, oxadixyl, oxycarboxin, penflufen, pyracarbolid, sedaxane, thifluzamide, tiadinil, vangard, benodanil, flutolanil, mebenil, mepronil, salicylanilide, tecloftalam, fenfuram, furalaxyl, furcarbanil, methfuroxam, flusulfamide, benzohydroxamic acid, fluopicolide, fluopyram, tioxymid, trichlamide, zarilamid, zoxamide, cyclafuramid, furmecyclox, dichlofluanid, tolylfluanid, amisulbrom, cyazofamid, benthiavalicarb, iprovalicarb, aureofungin, blasticidin-S, cycloheximide, griseofulvin, kasugamycin, moroxydine, natamycin, polyoxins, polyoxorim, streptomycin, validamycin, fluoxastrobin, mandestrobin, azoxystrobin, bifujunzhi, coumoxystrobin, enoxastrobin, flufenoxystrobin, jiaxiangjunzhi, picoxystrobin, pyraoxystrobin, pyraclostrobin, pyrametostrobin, triclopyricarb, dimoxystrobin, fenaminstrobin, metominostrobin, orysastrobin, kresoxim-methyl, trifloxystrobin, biphenyl, chlorodinitronaphthalenes, chloroneb, chlorothalonil, cresol, dicloran, fenjuntong, hexachlorobenzene, pentachlorophenol, quintozene, sodium pentachlorophenoxide, tecnazene, trichlorotrinitrobenzenes, asomate, urbacide, metrafenone, pyriofenone, albendazole, benomyl, carbendazim, chlorfenazole, cypendazole, debacarb, fuberidazole, mecarbinzid, rabenzazole, thiabendazole, furophanate, thiophanate, thiophanate-methyl, bentaluron, benthiavalicarb, benthiazole, chlobenthiazone, probenazole, allicin, berberine, carvacrol, carvone, osthol, sanguinarine, santonin, bithionol, dichlorophen, diphenylamine, hexachlorophene, parinol, benthiavalicarb, furophanate, iodocarb, iprovalicarb, picarbutrazox, propamocarb, pyribencarb, thiophanate, thiophanate-methyl, tolprocarb, albendazole, benomyl, carbendazim, cypendazole, debacarb, mecarbinzid, diethofencarb, pyraclostrobin, pyrametostrobin, triclopyricarb, climbazole, clotrimazole, imazalil, oxpoconazole, prochloraz, triflumizole, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, acypetacs-copper, Bordeaux mixture, Burgundy mixture, Cheshunt mixture, copper acetate, copper carbonate, copper hydroxide, copper naphthenate, copper oleate, copper oxychloride, copper silicate, copper sulphate, copper sulphate, copper zinc chromate, cuprobam, cuprous oxide, phenamacril, famoxadone, fluoroimide, chlozolinate, dichlozoline, iprodione, isovaledione, myclozolin, procymidone, vinclozolin, captafol, captan, ditalimfos, folpet, thiochlorfenphim, binapacryl, dinobuton, meptyldinocap, dinocton, dinopenton, dinosulfon, dinoterbon, amobam, asomate, azithiram, carbamorph, cufraneb, cuprobam, disulfiram, ferbam, metam, nabam, tecoram, thiram, urbacide, ziram, dazomet, mancozeb, maneb, metiram, polycarbamate, propineb, zineb, isoprothiolane, saijunmao, carbon disulfide, cyanogen, dithioether, methyl bromide, methyl iodide, sodium tetrathiocarbonate, benquinox, saijunmao, cyazofamid, fenamidone, fenapanil, glyodin, iprodione, isovaledione, pefurazoate, triazoxide, climbazole, clotrimazole, imazalil, oxpoconazole, prochloraz, triflumizole, potassium azide, potassium thiocyanate, sodium azide, sulfur, mercuric chloride, mercuric oxide, mercurous chloride, (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulphonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurea, phenylmercury acetate, phenylmercury chloride, phenylmercury derivative of pyrocatechol, phenylmercury nitrate, phenylmercury salicylate, thiomersal, tolylmercury acetate, aldimorph, benzamorf, carbamorph, dimethomorph, dodemorph, fenpropimorph, flumorph, tridemorph, ampropylfos, ditalimfos, edifenphos, fosetyl, hexylthiofos, inezin, iprobenfos, izopamfos, kejunlin, phosdiphen, pyrazophos, tolclofos-methyl, triamiphos, decafentin, fentin, tributyltin oxide, carboxin, oxycarboxin, chlozolinate, dichlozoline, drazoxolon, famoxadone, hymexazol, metazoxolon, myclozolin, oxadixyl, oxathiapiprolin, pyrisoxazole, vinclozolin, barium polysulfide, calcium polysulfide, potassium polysulfide, sodium polysulfide, benzovindiflupyr, bixafen, fenpyrazamine, fluxapyroxad, furametpyr, isopyrazam, oxathiapiprolin, penflufen, penthiopyrad, pyraclostrobin, pyrametostrobin, pyraoxystrobin, rabenzazole, sedaxane, boscalid, buthiobate, dipyrithione, fluazinam, fluopicolide, fluopyram, parinol, picarbutrazox, pyribencarb, pyridinitril, pyrifenox, pyrisoxazole, pyroxychlor, pyroxyfur, triclopyricarb, bupirimate, diflumetorim, dimethirimol, ethirimol, fenarimol, ferimzone, nuarimol, triarimol, cyprodinil, mepanipyrim, pyrimethanil, dimetachlone, fenpiclonil, fludioxonil, fluoroimide, berberine, sanguinarine, ethoxyquin, halacrinate, 8-hydroxyquinoline sulphate, quinacetol, quinoxyfen, tebufloquin, chloranil, dichlone, dithianon, chinomethionat, chlorquinox, thioquinox, etridiazole, saisentong, zinc thiazole, ethaboxam, isotianil, metsulfovax, octhilinone, oxathiapiprolin, thiabendazole, thifluzamide, flutianil, thiadifluor, methasulfocarb, prothiocarb, ethaboxam, isofetamid, silthiofam, anilazine, amisulbrom, bitertanol, fluotrimazole, huanjunzuo, triazbutil, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, ametoctradin, bentaluron, pencycuron, quinazamid, acypetacs-zinc, copper zinc chromate, cufraneb, mancozeb, metiram, polycarbamate, polyoxorim-zinc, propineb, zinc naphthenate, zinc thiazole, zinc trichlorophenoxide, zineb, ziram, acibenzolar, acypetacs, allyl alcohol, benzalkonium chloride, bethoxazin, bromothalonil, chitosan, chloropicrin, dehydroacetic acid, diclomezine, diethyl pyrocarbonate, ethylicin, fenaminosulf, fenitropan, fenpropidin, formaldehyde, furfural, hexachlorobutadiene, methyl isothiocyanate, nitrostyrene, nitrothal-isopropyl, pentachlorophenyl laurate, 2-phenylphenol, phthalide, piperalin, propamidine, proquinazid, pyroquilon, sodium orthophenylphenoxide, spiroxamine, sultropen, thicyofen or tricyclazole.
   N. The geotextile according to any one of example embodiments A to M, comprising the carrier material, wherein the carrier material is selected from the group of: clays, zeolites, polymers, gum Arabic, starches and carbon, and mixtures thereof.
   O. The geotextile according to any one of example embodiments A to N, when used to protect a surface or a sub-surface structure from damage caused by plant roots or microorganisms.
   P. The geotextile according to example embodiment O, wherein the surface or sub-surface structure is selected from: surface paths, roadways, foundations including building foundations, sub-surface fluid supply systems, sub-surface irrigation systems, buried drip pipes, drainage and water storage elements, capillary mats and conduits.
   Q. The geotextile according to any one of example embodiments A to N when used in a subsurface irrigation system and/or drainage system.
   R. The geotextile according to any one of example embodiments A to N or Q when used with a subsurface irrigation and/or drainage system of a type in which the geotextile is disposed in proximity to drippers or apertures, of an irrigation system and/or entry apertures of a drainage system.
   S. Use of a geotextile according to any one of example embodiments A to N to protect a surface or a sub-surface structure from damage caused by plant roots or microorganisms.
   T. The use according to example embodiment S, wherein the surface or sub-surface structure is selected from: surface paths, roadways, foundations including building foundations, sub-surface fluid supply systems, sub-surface irrigation systems, buried drip pipes, drainage and water storage elements, capillary mats and conduits.
   U. Use of a geotextile according to any one of example embodiments A to N or Q in a subsurface irrigation and/or drainage system of a type in which the geotextile is disposed in proximity to drippers or apertures, of an irrigation system and/or entry apertures of a drainage system.
   V. A subsurface fluid supply system comprising:
one or more conduits adapted to transport a fluid;
a connector on the one or more conduits adapted to connect to a source of fluid;
one or more fluid drippers or apertures, in each of the conduits; and
a geotextile according to any one of example embodiments A to N or Q to inhibit the growth of plant roots or microorganisms on or through a geotextile disposed in proximity to the one or more fluid drippers or apertures.
   W. The subsurface fluid supply system according to example embodiment V, wherein the subsurface fluid supply system comprises the geotextile as at least one discrete portion form, said discrete portion form adapted to overlay one or more of the one or more drippers or apertures, wherein the dimensions of the discrete portion are sufficient so as to effectively minimise or prevent root penetration into a dripper.
   X. The subsurface fluid supply system of example embodiment V, wherein the subsurface fluid supply system comprises the geotextile as a longitudinally extended strip form which overlays the one or more conduits adapted to transport a fluid in a manner so that at least one of the fluid drippers or apertures in the conduit is covered by the geotextile.
   Y. The subsurface fluid supply system of example embodiment X, wherein the longitudinally extended strip form covers all of the fluid drippers or apertures in the conduit.
   Z. The subsurface fluid supply system of example embodiment X or example embodiment U, further comprising a second longitudinally extended strip of a geotextile, wherein the one or more conduits adapted to transport a fluid is sandwiched between the longitudinally extended geotextile strips.
   AA. The subsurface fluid supply system of example embodiment Z, wherein the second longitudinally extended strip of a geotextile is a geotextile of any one of example embodiments A to N or Q.
   AB. The subsurface fluid supply system of example embodiment V, wherein the geotextile is adapted to completely encircle a portion of the one or more conduits adapted to transport a fluid proximate the dripper.
   AC. The subsurface fluid supply system of any one of example embodiments V to AA further comprising a water impermeable layer.
   AD. The subsurface fluid supply system of any one of example embodiments V to AC further comprising a water impermeable layer, wherein the one or more conduits adapted to transport a fluid are sandwiched between the geotextile and said water impermeable layer.
   AE. The subsurface fluid supply system of any one of example embodiments V to AD further comprising a deflector strip, wherein said deflector strip prevents water from moving through it and directs fluid discharged from the drippers or apertures to move in a horizontally or vertically direction, relative to the position of the deflector strip in relation to the drippers or apertures, through the geotextile material.
   AF. Use of a geotextile according to any one of example embodiments A to N to prevent roots and/or microorganisms growing in joints present in subsurface conduits.
   AG. The use according to example embodiment AF wherein the conduits carry cables including copper cables or optical fibre.
   AH. A method of irrigation, wherein the geotextile according to any one of example embodiments A to N or Q or the subsurface fluid supply system according to any one of example embodiments V to AE is used to irrigate an area of land.
   AI. The method of example embodiment AH, wherein the geotextile or the subsurface fluid supply system protects surface and subsurface structures from damage caused by plant roots or microorganisms and reduces plant and human pathogen levels in water.
   AJ. The method of example embodiment AI, wherein the subsurface structure is selected from the group comprising: buried drip pipes, drainage and water storage elements, capillary mats and conduits.
   AK. A method of protecting a surface or a sub-surface structure from damage caused by plant roots or microorganisms, the method comprising providing a geotextile according to any one of example embodiments A to N adjacent, above or below the surface or sub-surface structure.
   AL. The method according to example embodiment AK, wherein the surface or sub-surface structure is selected from: surface paths, roadways, foundations, including building foundations, sub-surface fluid supply systems, sub-surface irrigation systems, buried drip pipes, drainage and water storage elements, capillary mats and conduits.

### Examples

In order to demonstrate the efficacy of the root inhibiting properties of the a geotextile as disclosed herein, the following experiments were performed:

### Experiment 1

A square of geotextile was buried horizontally midway down a pot filled with soil and planted with rye grass. Each square was divided into quadrants three were dusted with either copper, zinc or aluminium powder and the fourth was left untreated. Copper was applied at a rate of 150 gCu/m²; the zinc and aluminium powders were applied in a roughly equivalent amount. Treatments were replicated by 3 pots and these were placed on the ground in full sun and hand watered.

When all pots were filled with roots evidenced by roots growing from the drainage holes, the trial was terminated.

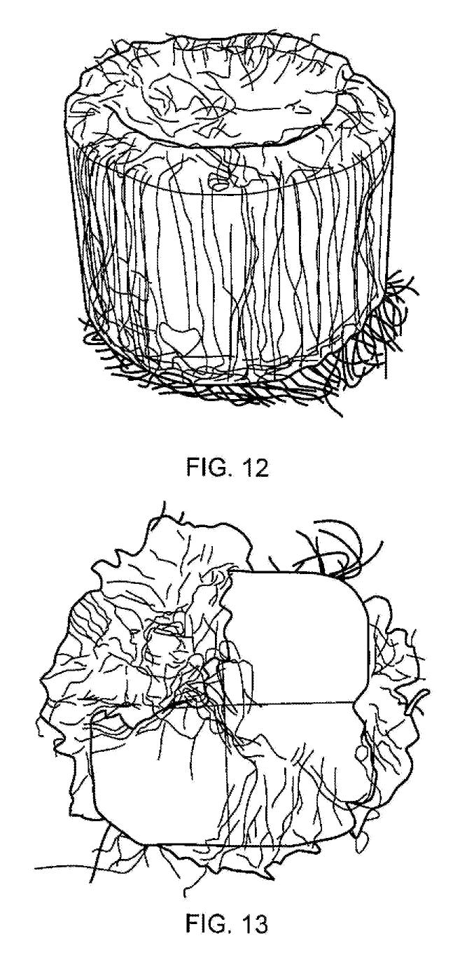

Pots were then upended and the soil carefully removed to expose the geotextile square without damaging roots (FIG. 12; FIG. 13: top-left=control; top-right=copper; bottom left=zinc; bottom right=aluminium). The extent of root penetration into the geotextile in each quadrant was scored with reference to root numbers in the untreated section which was given a score of 5. A score of 0 means no roots were found in the geotextile.

### Results:

| Treatment | Score |
|---|---|
| Control | 5 |
| Copper | 0 |
| Zinc | 1.5 |
| Aluminium | 5 |

### Findings:

Although roots grew freely into the untreated geotextile, no roots were found in the section of the geotextile treated with copper. The section treated with zinc had some roots but significantly less than the control.

### Experiment 2

Short sections of drip pipe were plugged at one end and buried in pots of soil sown with rye grass. Discrete portions of geotextile were placed over a single functioning emitter in each pipe. Discrete portions received the following treatments:
control (untreated geotextile);
copper powder;
zinc powder; and
aluminium powder.

These treatments were applied either on the inside or the outside of the geotextile discrete portions.

Copper was applied at the same rate as used in the first experiment. Zinc and aluminium were applied at approximately equivalent amounts.

Pots were replicated by 3 and placed on a bench in full sun. These were hand watered until the pots were filled with roots.

Hand watering was then stopped and the soil was allowed to dry. After 2 days of drying, a small aliquot of water was then applied into the open end of each pipe every day. This water slowly leaked into the soil from the buried emitter. The soil moisture gradient produced by this method of irrigation was designed to encourage roots to grow towards the emitter.

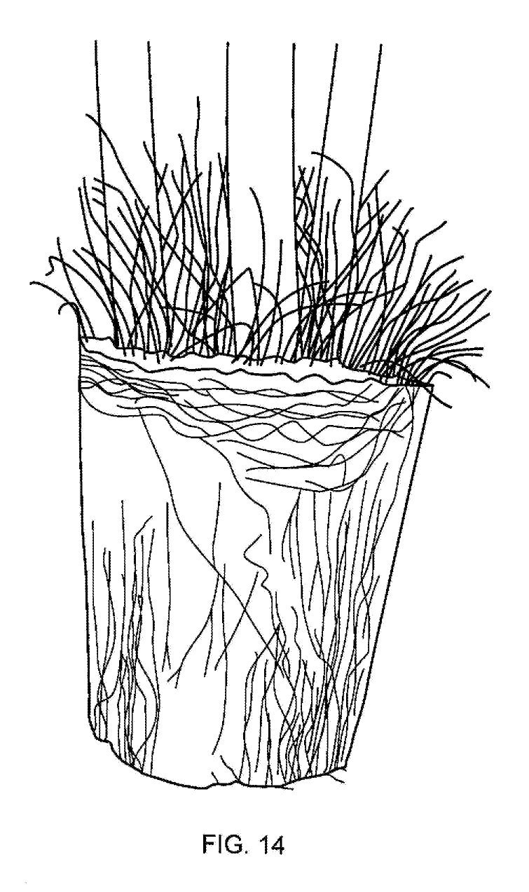

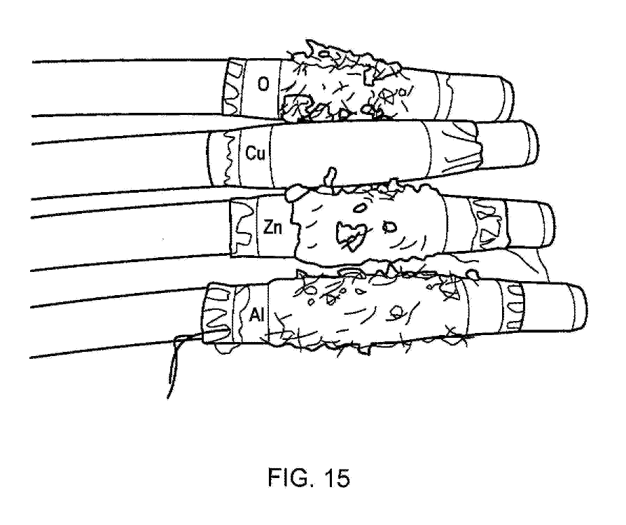

After a week, the trial was terminated. The sections of irrigation pipe were carefully removed from each pot with the geotextile discrete portions still attached (FIG. 14 and FIG. 15). These were examined and scored for root penetration in the same way as for Experiment 1.

### Results:

| | Score | |
|---|---|---|
| Treatment | Inside | Outside |
| Control | 5 | 5 |
| Copper | 0 | 0 |
| Zinc | 2 | 0 |
| Aluminium | 4 | 5 |

### Findings:

No roots grew into the geotextile discrete portions treated with copper irrespective of the side the powder was applied.

Moreover, it will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

1. A geotextile comprising:
a plant root inhibiting amount or microorganism inhibiting amount of: one or more metals or one or more metal containing compounds thereof, or a mixture of the foregoing; and
optionally an organic compound selected from a group consisting of: an algaecide, an herbicide, a pesticide, a fungicide, or a mixture thereof, held in a carrier material,
wherein the one or more metals, the one or more metal containing compounds thereof, or a mixture of the foregoing inhibits the growth of plant roots or microorganisms on or through the geotextile.

2. The geotextile according to claim 1 wherein the geotextile comprises one or more metals selected from: copper, zinc, aluminium or manganese, or a mixture thereof.

3. The geotextile according to claim 1, wherein the geotextile comprises one or more of a metal containing compound selected from: copper compounds, zinc compounds, aluminium compounds or manganese compounds, or a mixture thereof.

4. The geotextile according to claim 1, wherein the one or more metal containing compounds are selected from: copper oxide, copper sulphate, copper hydroxide, copper nitrate, aluminium sulphate, aluminium nitrate, zinc sulphate, zinc permanganate, zinc carbonate, manganese carbonate, manganese fluoride, manganese hydroxide, or a mixture thereof.

5. The geotextile according to claim 1, wherein the one or more metal containing compounds are substantially insoluble in water or insoluble in water.

6. The geotextile according to claim 1, wherein the geotextile comprises metallic copper.

7. (canceled)

8. The geotextile according to claim 1, wherein the one or more metals or the one or more metal containing compounds is in a particulate form.

9. The geotextile according to claim 1, wherein the one or more metals, one or more metal containing compounds, or a mixture of thereof is in a form selected from the group consisting of a foil strip or a mesh.

10. The geotextile according to claim 1, wherein the one or more metals, one or more metal containing compounds, or a mixture of thereof is present in an amount of about 1 g/m² to about 400 g/m², or about 20 g/m² to about 200 g/m², or about 40 g/m² to about 100 g/m², or about 40 g/m² to about 80 g/m² or about 5 g/m² to about 20 g/m².

11. (canceled)

12. The geotextile according to claim 1, comprising the algaecide, the herbicide, the pesticide, the fungicide, or a mixture thereof, held in a carrier material, wherein:
the algaecide is selected from: copper based algaecides including copper salt based algaecides, silver algaecides including colloidal silver based algaecides and silver salt based algaecides, quat based algaecides or polyquat based algaecides;
the herbicide is selected from: amide based herbicides, anilide based herbicides, arylalanine based herbicides, chloroacetanilide based herbicides, sulfonanilide based herbicides, sulfonamide based herbicides, thioamide based herbicides, aromatic acid based herbicides, benzoic acid based herbicides, pyrimidinyloxybenzoic acid based herbicides, pyrimidinylthiobenzoic acid based herbicides, phthalic acid based herbicides, picolinic acid based herbicides, quinolinecarboxylic acid based herbicides, arsenical based herbicides, benzoylcyclohexanedione based herbicides, benzofuranyl alkylsulfonate based herbicides, benzothiazole based herbicides, carbamate based herbicides, carbanilate based herbicides, carbonate based herbicides, cyclohexene oxime based herbicides, cyclopropylisoxazole based herbicides, dicarboximide based herbicides, dinitroaniline based herbicides, dinitrophenol based herbicides, diphenyl ether based herbicides, nitrophenyl ether based herbicides, dithiocarbamate based herbicides, fumigant based herbicides, halogenated aliphatic based herbicides, imidazolinone based herbicides, nitrile based herbicides, organophosphorus based herbicides, oxadiazolone based herbicides, oxazole based herbicides, phenoxy based herbicides, phenoxyacetic based herbicides, phenoxybutyric based herbicides, phenoxypropionic based herbicides, aryloxyphenoxypropionic based herbicides, phenylenediamine based herbicides, pyrazole based herbicides, benzoylpyrazole based herbicides, phenylpyrazole based herbicides, pyridazine based herbicides, pyridazinone based herbicides, pyridine based herbicides, pyrimidinediamine based herbicides, pyrimidinyloxybenzylamine based herbicides, quaternary ammonium based herbicides, thiocarbamate based herbicides, thiocarbonate based herbicides, thiourea based herbicides, triazine based herbicides, chlorotriazine based herbicides, fluoroalkyltriazine based herbicides, methoxytriazine based herbicides, methylthiotriazine based herbicides, triazinone based herbicides, triazole based herbicides, triazolone based herbicides, triazolopyrimidine based herbicides, uracil based herbicides, urea based herbicides, phenylurea based herbicides, sulfonylurea based herbicides, pyrimidinylsulfonylurea based herbicides, triazinylsulfonylurea based herbicides or thiadiazolylurea based herbicides;
the pesticide is selected from: pyrethroids, organophosphates, carbamates, thiocarbamates, organochlorines including chlorinated hydrocarbons; and/or
the fungicide is selected from: natural plant oils, natural sulphur based fungicides, aliphatic nitrogen based fungicides, amide based fungicides, acylamino acid based fungicides, anilide based fungicides, benzanilide based fungicides, furanilide based fungicides, sulfonanilide based fungicides, benzamide based fungicides, furamide based fungicides, phenylsulfamide based fungicides, sulfonamide based fungicides, valinamide based fungicides, antibiotic based fungicides, strobilurin based fungicides, methoxyacrylate strobilurin based fungicides, methoxycarbanilate strobilurin based fungicides, methoxyiminoacetamide strobilurin based fungicides, methoxyiminoacetate strobilurin based fungicides, arsenical based fungicides, aryl phenyl ketone based fungicides, benzimidazole based fungicides, benzimidazole precursor based fungicides, benzothiazole based fungicides, bridged diphenyl based fungicides, carbamate based fungicides, benzimidazolylcarbamate based fungicides, carbanilate based fungicides, conazole based fungicides, conazole fungicides that are based on imidazoles, conazole fungicides that are based on triazoles, copper based fungicides, cyanoacrylate based fungicides, dicarboximide based fungicides, dichlorophenyl dicarboximide based fungicides, phthalimide based fungicides, dinitrophenol based fungicides, dithiocarbamate based fungicides, cyclic dithiocarbamate based fungicides, polymeric dithiocarbamate based fungicides, dithiolane based fungicides, fumigant based fungicides, hydrazide based fungicides, imidazole based fungicides, mercury based fungicides, inorganic mercury based fungicides, organomercury based fungicides, morpholine based fungicides, organophosphorus based fungicides, organotin based fungicides, oxathiin based fungicides, oxazole based fungicides, polysulfide based fungicides, pyrazole based fungicides, pyridine based fungicides, pyrimidine based fungicides, anilinopyrimidine based fungicides, pyrrole based fungicides, quaternary ammonium based fungicides, quinoline based fungicides, quinone based fungicides, quinoxaline based fungicides, thiadiazole based fungicides, thiazole based fungicides, thiazolidine based fungicides, thiocarbamate based fungicides, thiophene based fungicides, triazine based fungicides, triazole based fungicides, triazolopyrimidine based fungicides, urea based fungicides or zinc based fungicides.

13. The geotextile according to claim 12, wherein the carrier material is selected from the group of: clays, zeolites, polymers, gum Arabic, starches and carbon, and mixtures thereof.

14-20. (canceled)

21. A subsurface fluid supply system comprising:
one or more conduits adapted to transport a fluid;
a connector on the one or more conduits adapted to connect to a source of fluid;
one or more fluid drippers or apertures, in each of the conduits; and
a geotextile according to claim 1 to inhibit the growth of plant roots or microorganisms on or through a geotextile disposed in proximity to the one or more fluid drippers or apertures.

22. The subsurface fluid supply system according to claim 21, wherein the subsurface fluid supply system comprises the geotextile as at least one discrete portion form, said discrete portion form adapted to overlay one or more of the one or more drippers or apertures, wherein the dimensions of the discrete portion are sufficient so as to effectively minimise or prevent root penetration into a dripper.

23. The subsurface fluid supply system of claim 21, wherein the subsurface fluid supply system comprises the geotextile as a longitudinally extended strip form which overlays the one or more conduits adapted to transport a fluid in a manner so that at least one of the fluid drippers or apertures, in the conduit is covered by the geotextile.

24. The subsurface fluid supply system of claim 23, wherein the longitudinally extended strip form covers all of the fluid drippers or apertures, in the conduit.

25. The subsurface fluid supply system of claim 23, further comprising a second longitudinally extended strip of a geotextile, wherein the one or more conduits adapted to transport a fluid is sandwiched between the longitudinally extended geotextile strips.

26. (canceled)

27. The subsurface fluid supply system of claim 21, wherein the geotextile is adapted to completely encircle a portion of the one or more conduits adapted to transport a fluid proximate the dripper.

28. The subsurface fluid supply system of claim 21 further comprising a water impermeable layer.

29. The subsurface fluid supply system of claim 21 wherein the one or more conduits adapted to transport a fluid are sandwiched between the geotextile and the water impermeable layer.

30. The subsurface fluid supply system of claim 21 further comprising a deflector strip, wherein said deflector strip prevents water from moving through it and directs fluid discharged from the drippers or apertures, to move in a horizontally or vertically direction, relative to the position of the deflector strip in relation to the drippers or apertures, through the geotextile material.

31-37. (canceled)
